(19) United States
(12) Patent Application Publication
(10) Pub. No.: US 2026/0003243 A1
(43) Pub. Date: Jan. 1, 2026

(54) VARIABLE LIGHT TRANSMISSION DEVICE COMPRISING MICROCELLS

(71) Applicant: E INK CORPORATION, Billerica, MA (US)

(72) Inventors: Bryan DUNN, Medford, MA (US); Yu XIA, Acton, MA (US); George G. HARRIS, Woburn, MA (US)

(21) Appl. No.: 19/247,047

(22) Filed: Jun. 24, 2025

Related U.S. Application Data
(60) Provisional application No. 63/664,321, filed on Jun. 26, 2024.

(51) Int. Cl. G02F 1/1679; G02F 1/167; G02F 1/1685

(52) U.S. Cl. CPC G02F 1/1679; G02F 1/167; G02F 1/1685

(57) ABSTRACT

A variable light transmission device is disclosed that mitigates negative aperture diffraction effects and shows good switching speed between the open and the closed optical states. The device comprises a microcell layer disposed between two light transmissive electrode layers, the microcell layer having a plurality of microcells, each microcell including an electrophoretic medium, and each microcell comprising a channel, a protrusion structure, the protrusion structure comprising a conoid geometric solid.

### RELATED APPLICATION

This application claims priority to U.S. Provisional Patent Application No. 63/664,321 filed on Jun. 26, 2024, which is incorporated by reference in its entirety, along with all other patents and patent applications disclosed herein.

### BACKGROUND OF THE INVENTION

This invention relates to a variable light transmission device. Specifically, the invention relates to a microcell electro-optic device comprising an electrophoretic medium comprising electrically charged pigment particles and a non-polar liquid. The electrophoretic medium can switch between optical states using electric fields. The variable light transmission device can modulate the amount of light and other electromagnetic radiation passing through them. It can be used on mirrors, windows, sunroofs, and similar items. For example, the present invention may be applied on windows that can modulate light that enters buildings and vehicles. Examples of electrophoretic media that may be incorporated into various embodiments of the present invention include, for example, the electrophoretic media described in U.S. Pat. Nos. 7,116,466, 7,327,511, 8,576,476, 10,319,314, 10,809,590, 10,067,398, 10,067,398, and 11,143,930, and U.S. Patent Application Publication Nos. 2014/0055841, 2017/0351155, 2017/0235206, 2011/0199671, 2020/0355979, 2020/0272017, 2021/0096439, and U.S. patent application Ser. No. 17/953,386, filed on Sep. 27, 2022, the contents of which are incorporated by reference herein in their entireties.

Particle-based electrophoretic displays, in which a plurality of electrically charged pigment particles move through a suspending fluid under the influence of an electric field, have been the subject of intense research and development for a number of years. Such displays can have attributes of good brightness and contrast, wide viewing angles, state bistability, and low power consumption when compared with liquid crystal displays.

The terms “bistable” and “bistability” are used herein in their conventional meaning in the art to refer to displays comprising display elements having first and second display states differing in at least one optical property, and such that after any given element has been driven by means of an addressing pulse of finite duration, to assume either its first or second display state, after the addressing pulse has terminated, that state will persist for at least several times, for example at least four times, the minimum duration of the addressing pulse required to change the state of the display element. It is shown in published U.S. Patent Application Ser. No. 2002/0180687 that some particle-based electrophoretic displays capable of gray scale are stable not only in their extreme black and white states but also in their intermediate gray states, and the same is true of some other types of electro-optic displays. This type of display is properly called “multi-stable” rather than bistable, although for convenience the term “bistable” may be used herein to cover both bistable and multi-stable displays.

As noted above, electrophoretic media require the presence of a suspending fluid. In most prior art electrophoretic media, this suspending fluid is a liquid, but electrophoretic media can be produced using gaseous suspending fluids. Such gas-based electrophoretic media appear to be susceptible to the same types of problems due to particle settling as liquid-based electrophoretic media, when the media are used in an orientation which permits such settling, for example in a sign where the medium is disposed in a vertical plane. Indeed, particle settling appears to be a more serious problem in gas-based electrophoretic media than in liquid-based ones, since the lower viscosity of gaseous suspending fluids as compared with liquid ones allows more rapid settling of the electrically charged pigment particles.

Numerous patents and applications assigned to or in the names of the Massachusetts Institute of Technology (MIT), E Ink Corporation, E Ink California, LLC, and related companies describe various technologies used in encapsulated and microcell electrophoretic and other electro-optic media. Encapsulated electrophoretic media comprise numerous small capsules, each of which comprises an internal phase containing electrophoretically-mobile particles in a liquid medium, and a capsule wall surrounding the internal phase. Typically, the capsules are themselves held within a polymeric binder to form a coherent layer positioned between two electrodes. In a microcell electrophoretic display, the electrically charged pigment particles and the liquid are not encapsulated within microcapsules but instead are retained within a plurality of cavities formed within a carrier medium, typically a polymeric film. The technologies described in these patents and applications include:
(a) Electrophoretic particles, fluids and fluid additives; see for example U.S. Pat. Nos. 5,961,804; 6,017,584; 6,120,588; 6,120,839; 6,262,706; 6,262,833; 6,300,932; 6,323,989; 6,377,387; 6,515,649; 6,538,801; 6,580,545; 6,652,075; 6,693,620; 6,721,083; 6,727,881; 6,822,782; 6,831,771; 6,870,661; 6,927,892; 6,956,690; 6,958,849; 7,002,728; 7,038,655; 7,052,766; 7,110,162; 7,113,323; 7,141,688; 7,142,351; 7,170,670; 7,226,550; 7,230,750; 7,230,751; 7,236,290; 7,277,218; 7,286,279; 7,312,916; 7,382,514; 7,390,901; 7,473,782; 7,561,324; 7,583,251; 7,572,394; 7,576,904; 7,580,180; 7,679,814; 7,848,006; 7,903,319; 8,018,640; 8,115,729; 8,257,614; 8,270,064; 8,363,306; 8,390,918; 8,582,196; 8,654,436; 8,902,491; 8,961,831; 9,052,564; 9,341,915; 9,348,193; 9,361,836; 9,366,935; 9,372,380; 9,382,427; 9,423,666; 9,428,649; 9,557,623; 9,670,367; 9,671,667; 9,688,859; 9,726,957; 9,752,034; 9,765,015; 9,778,535; 9,778,537; 9,835,926; 9,953,588; 9,995,987; 10,025,157; 10,031,394; 10,040,954; 10,061,123; 10,062,337; 10,147,366; and 10,514,583; and U.S. Patent Application Publication Nos. 2003/0048522; 2003/0151029; 2003/0164480; 2004/0030125; 2004/0105036; 2005/0012980; 2009/0009852; 2011/0217639; 2012/0049125; 2013/0161565; 2013/0193385; 2013/0244149; 2013/0063333; 2014/0011913; 2014/0078576; 2014/0104674; 2014/0231728; 2015/0177590; 2015/0185509; 2015/0241754; 2015/0301425; and 2016/0170106;
(b) Capsules, binders and encapsulation processes; see for example U.S. Pat. Nos. 5,930,026; 6,067,185; 6,130,774; 6,262,706; 6,327,072; 6,392,786; 6,459,418; 6,727,881, 6,839,158; 6,866,760; 6,922,276; 6,958,848; 6,987,603; 7,110,164; 7,148,128; 7,184,197; 7,304,634; 7,327,511, 7,339,715; 7,411,719; 7,477,444; 7,561,324; 7,910,175; 7,952,790; 8,129,655; 8,446,664; and U.S. Patent Applications Publication Nos. 2005/0156340; 2007/0091417; and 2009/0122389;
(c) Microcell structures, wall materials, and methods of forming microcells; see for example U.S. Pat. Nos. 6,672,921; 6,751,007; 6,753,067; 6,781,745; 6,788,452; 6,795,229; 6,806,995; 6,829,078; 6,850,355; 6,865,012; 6,870,662; 6,885,495; 6,930,818; 6,933,098; 6,947,202; 7,046,228; 7,072,095; 7,079,303; 7,141,279; 7,156,945; 7,205,355; 7,233,429; 7,261,920; 7,271,947; 7,304,780; 7,307,778; 7,327,346; 7,347,957; 7,470,386; 7,504,050; 7,580,180; 7,715,087; 7,767,126; 7,880,958; 8,002,948; 8,154,790; 8,169,690; 8,441,432; 8,891,156; 9,279,906; 9,291,872; 9,388,307; 9,436,057; 9,436,058; 9,470,917; 9,919,553; and 10,401,668; and U.S. Patent Applications Publication Nos. 2003/0203101; 2014/0050814; and 2016/0059442;
(d) Methods for filling and sealing microcells; see for example U.S. Pat. Nos. 6,545,797; 6,788,449; 6,831,770; 6,833,943; 6,930,818; 7,046,228; 7,052,571; 7,166,182; 7,347,957; 7,374,634; 7,385,751; 7,408,696; 7,557,981; 7,560,004; 7,564,614; 7,572,491; 7,616,374; 7,715,087; 7,715,088; 8,361,356; 8,625,188; 8,830,561; 9,346,987; and 9,759,978; and U.S. Patent Applications Publication Nos. 2002/0188053; 2004/0120024; 2004/0219306; and 2015/0098124;
(e) Films and sub-assemblies containing electro-optic materials; see for example U.S. Pat. Nos. 6,825,829; 6,982,178; 7,110,164; 7,158,282; 7,554,712; 7,561,324; 7,649,666; 7,728,811; 7,826,129; 7,839,564; 7,843,621; 7,843,624; 7,952,790; 8,034,209; 8,177,942; 8,390,301; 9,238,340; 9,470,950; 9,835,925; and U.S. Patent Applications Publication Nos. 2005/0122563; 2007/0237962; and 2011/0164301;
(f) Backplanes, adhesive layers and other auxiliary layers and methods used in displays; see for example U.S. Patents Nos. D485,294; 5,930,026; 6,120,588; 6,124,851; 6,177,921; 6,232,950; 6,252,564; 6,312,304; 6,312,971; 6,376,828; 6,392,786; 6,413,790; 6,480,182; 6,498,114; 6,506,438; 6,518,949; 6,545,291; 6,639,578; 6,657,772; 6,664,944; 6,683,333; 6,710,540;_6,724,519; 6,816,147; 6,819,471; 6,825,068; 6,831,769; 6,842,279; 6,842,657; 6,865,010; 6,873,452; 6,909,532; 6,967,640; 7,012,600; 7,012,735; 7,030,412; 7,075,703; 7,106,296; 7,110,163; 7,116,318; 7,148,128; 7,167,155; 7,173,752; 7,176,880; 7,190,008; 7,206,119; 7,223,672; 7,230,751; 7,256,766; 7,259,744; 7,301,693; 7,304,780; 7,327,346; 7,327,511; 7,347,957; 7,365,733; 7,388,572; 7,401,758; 7,492,497; 7,535,624; 7,551,346; 7,554,712; 7,560,004; 7,583,427; 7,649,674; 7,667,886; 7,672,040; 7,688,497; 7,826,129; 7,830,592; 7,839,564; 7,880,958; 7,893,435; 7,905,977; 7,952,790; 7,986,450; 8,034,209; 8,049,947; 8,072,675; 8,120,836; 8,159,636; 8,177,942; 8,237,892; 8,362,488; 8,395,836; 8,437,069; 8,441,414; 8,456,589; 8,514,168; 8,547,628; 8,576,162; 8,610,988; 8,714,780; 8,743,077; 8,754,859; 8,797,258; 8,797,633; 8,797,636; 9,147,364; 9,025,234; 9,025,238; 9,030,374; 9,140,952; 9,201,279; 9,223,164; 9,238,340; 9,285,648; 9,454,057; 9,529,240; 9,620,066; 9,632,373; 9,666,142; 9,671,635; 9,715,155; 9,777,201; 9,897,891; 10,037,735; 10,190,743; 10,324,577; 10,365,533; 10,372,008; 10,446,585; 10,466,565; 10,495,941; 10,503,041; 10,509,294; 10,613,407; and U.S. Patent Applications Publication Nos. 2002/0060321; 2004/0085619; 2004/0105036; 2005/0122306; 2005/0122563; 2006/0255322; 2009/0122389; 2010/0177396; 2011/0164301; 2011/0292319; 2014/0192000; 2014/0210701; 2014/0368753; and 2016/0077375; and International Application Publication Nos. WO2000/038000; WO2000/005704; and WO1999/067678;
(g) Color formation and color adjustment; see for example U.S. Pat. Nos. 6,017,584; 6,545,797; 6,664,944; 6,788,452; 6,864,875; 6,914,714; 6,972,893; 7,038,656; 7,038,670; 7,046,228; 7,052,571; 7,075,502; 7,167,155; 7,385,751; 7,492,505; 7,667,684; 7,684,108; 7,791,789; 7,800,813; 7,821,702; 7,839,564; 7,910,175; 7,952,790; 7,956,841; 7,982,941; 8,040,594; 8,054,526; 8,098,418; 8,159,636; 8,213,076; 8,363,299; 8,422,116; 8,441,714; 8,441,716; 8,466,852; 8,503,063; 8,576,470; 8,576,475; 8,593,721; 8,605,354; 8,649,084; 8,670,174; 8,704,756; 8,717,664; 8,786,935; 8,797,634; 8,810,899; 8,830,559; 8,873,129; 8,902,153; 8,902,491; 8,917,439; 8,964,282; 9,013,783; 9,116,412; 9,146,439; 9,164,207; 9,170,467; 9,170,468; 9,182,646; 9,195,111; 9,199,441; 9,268,191; 9,285,649; 9,293,511; 9,341,916; 9,360,733; 9,361,836; 9,383,623; and 9,423,666; and U.S. Patent Applications Publication Nos. 2008/0043318; 2008/0048970; 2009/0225398; 2010/0156780; 2011/0043543; 2012/0326957; 2013/0242378; 2013/0278995; 2014/0055840; 2014/0078576; 2014/0340430; 2014/0340736; 2014/0362213; 2015/0103394; 2015/0118390; 2015/0124345; 2015/0198858; 2015/0234250; 2015/0268531; 2015/0301246; 2016/0011484; 2016/0026062; 2016/0048054; 2016/0116816; 2016/0116818; and 2016/0140909;
(h) Methods for driving displays; see for example U.S. Pat. Nos. 5,930,026; 6,445,489; 6,504,524; 6,512,354; 6,531,997; 6,753,999; 6,825,970; 6,900,851; 6,995,550; 7,012,600; 7,023,420; 7,034,783; 7,061,166; 7,061,662; 7,116,466; 7,119,772; 7,177,066; 7,193,625; 7,202,847; 7,242,514; 7,259,744; 7,304,787; 7,312,794; 7,327,511; 7,408,699; 7,453,445; 7,492,339; 7,528,822; 7,545,358; 7,583,251; 7,602,374; 7,612,760; 7,679,599; 7,679,813; 7,683,606; 7,688,297; 7,729,039; 7,733,311; 7,733,335; 7,787,169; 7,859,742; 7,952,557; 7,956,841; 7,982,479; 7,999,787; 8,077,141; 8,125,501; 8,139,050; 8,174,490; 8,243,013; 8,274,472; 8,289,250; 8,300,006; 8,305,341; 8,314,784; 8,373,649; 8,384,658; 8,456,414; 8,462,102; 8,514,168; 8,537,105; 8,558,783; 8,558,785; 8,558,786; 8,558,855; 8,576,164; 8,576,259; 8,593,396; 8,605,032; 8,643,595; 8,665,206; 8,681,191; 8,730,153; 8,810,525; 8,928,562; 8,928,641; 8,976,444; 9,013,394; 9,019,197; 9,019,198; 9,019,318; 9,082,352; 9,171,508; 9,218,773; 9,224,338; 9,224,342; 9,224,344; 9,230,492; 9,251,736; 9,262,973; 9,269,311; 9,299,294; 9,373,289; 9,390,066; 9,390,661; and 9,412,314; and U.S. Patent Applications Publication Nos. 2003/0102858; 2004/0246562; 2005/0253777; 2007/0091418; 2007/0103427; 2007/0176912; 2008/0024429; 2008/0024482; 2008/0136774; 2008/0291129; 2008/0303780; 2009/0174651; 2009/0195568; 2009/0322721; 2010/0194733; 2010/0194789; 2010/0220121; 2010/0265561; 2010/0283804; 2011/0063314; 2011/0175875; 2011/0193840; 2011/0193841; 2011/0199671; 2011/0221740; 2012/0001957; 2012/0098740; 2013/0063333; 2013/0194250; 2013/0249782; 2013/0321278; 2014/0009817; 2014/0085355; 2014/0204012; 2014/0218277; 2014/0240210; 2014/0240373; 2014/0253425; 2014/0292830; 2014/0293398; 2014/0333685; 2014/0340734; 2015/0070744; 2015/0097877; 2015/0109283; 2015/0213749; 2015/0213765; 2015/0221257; 2015/0262255; 2015/0262551; 2016/0071465; 2016/0078820; 2016/0093253; 2016/0140910; and 2016/0180777;
(i) Applications of displays; see for example U.S. Pat. Nos. 6,118,426; 6,473,072; 6,704,133; 6,710,540; 6,738,050; 6,825,829; 7,030,854; 7,119,759; 7,312,784; 7,705,824; 8,009,348; 8,011,592; 8,064,962; 8,162,212; 8,553,012; 8,973,837; 9,188,829; and 9,197,704; and U.S. Patent Applications Publication Nos. 2002/0090980; 2004/0119681; 2007/0285385; 2013/0176288; 2013/0221112; 2013/0233930; 2013/0235536; 2014/0049808; 2014/0062391; 2014/0206292; and 2016/0035291; and International Application Publication No. WO 00/36560; and
(j) Non-electrophoretic displays, as described in U.S. Pat. Nos. 6,241,921; 6,784,953; 6,795,138; 6,914,713; 6,950,220; 7,095,477; 7,182,830; 7,245,414; 7,420,549; 7,471,369; 7,576,904; 7,580,180; 7,850,867; 8,018,643; 8,023,071; 8,282,762; 8,319,759; and 8,994,705 and U.S. Patent Applications Publication Nos. 2005/0099575; 2006/0262249; 2007/0042135; 2007/0153360; 2008/0020007; 2012/0293858; and 2015/0277160; and applications of encapsulation and microcell technology other than displays; see for example U.S. Pat. No. 7,615,325; and U.S. Patent Application Publications Nos. 2015/0005720 and 2016/0012710.

Many of the aforementioned patents and applications recognize that the wall surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of a non-polar liquid and a continuous phase of a polymeric material, and that the discrete droplets of electrophoretic medium within such a polymer-dispersed electrophoretic display may be regarded as capsules or microcapsules even though no discrete capsule membrane is associated with each individual droplet; see for example, the aforementioned 2002/0131147. Accordingly, for purposes of the present application, such polymer-dispersed electrophoretic media are regarded as sub-species of encapsulated electrophoretic media.

A related type of electrophoretic display is a so-called “microcell electrophoretic display”. In a microcell electrophoretic display, the electrically charged pigment particles and the suspending liquid are not encapsulated within microcapsules but instead are retained within a plurality of cavities formed within a carrier medium, typically a polymeric film. See, for example, International Application Publication No. WO 02/01281, and published U.S. application Ser. No. 2002/0075556, both assigned to Sipix Imaging, Inc.

Although electrophoretic media are often opaque (since, for example, in many electrophoretic media, the particles substantially block transmission of visible light through the display) and operate in a reflective mode, many electrophoretic displays can be made to operate in a so-called “shutter mode” in which one display state is substantially opaque and one is light-transmissive. See, for example, U.S. Pat. Nos. 6,130,774 and 6,172,798, and U.S. Pat. Nos. 5,872,552; 6,144,361; 6,271,823; 6,225,971; and 6,184,856. Dielectrophoretic displays, which are similar to electrophoretic displays but rely upon variations in electric field strength, can operate in a similar mode; see U.S. Pat. No. 4,418,346. Other types of electro-optic displays may also be capable of operating in shutter mode.

An encapsulated or microcell electrophoretic display typically does not suffer from the clustering and settling failure mode of traditional electrophoretic devices and provides further advantages, such as the ability to print or coat the display on a wide variety of flexible and rigid substrates. Use of the word “printing” is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition; and other similar techniques. Thus, the resulting display can be flexible. Further, because the display medium can be printed (using a variety of methods), the display itself can be made inexpensively.

One potentially important market for electrophoretic media is windows with variable light transmission. As the energy performance of buildings and vehicles becomes increasingly important, electrophoretic media could be used as coatings on windows to enable the proportion of incident radiation transmitted through the windows to be electronically controlled by varying the optical state of the electrophoretic media. Effective implementation of such “variable transmissivity” (“VT”) technology in buildings is expected to provide (1) reduction of unwanted heating effects during hot weather, thus reducing the amount of energy needed for cooling, the size of air conditioning plants, and peak electricity demand; (2) increased use of natural daylight, thus reducing energy used for lighting and peak electricity demand; and (3) increased occupant comfort by increasing both thermal and visual comfort. Even greater benefits would be expected to accrue in an automobile, where the ratio of glazed surface to enclosed volume is significantly larger than in a typical building. Specifically, effective implementation of VT technology in automobiles is expected to provide not only the aforementioned benefits but also (1) increased motoring safety, (2) reduced glare, (3) enhanced mirror performance (by using an electro-optic coating on the mirror), and (4) increased ability to use heads-up displays. Other potential applications of VT technology include privacy glass and glare-guards in electronic devices.

The art provides examples of devices comprising electrophoretic media sandwiched by electrode layers that are able to achieve a closed optical state (opaque state) and an open optical state (transparent state) and to switch between these states by application of electric fields across the electrophoretic medium. However, conventional electrophoretic devices using conventional structures and waveforms require long switching times. Furthermore, light from a bright object such as a light source in a dark ambient environment or specular reflections of the sun in a bright ambient environment, when it passes through the device may be subject to diffraction phenomena that can be visible or even disturbing to a viewer, making the devices less desirable. The inventors of the present invention unexpectedly found that devices comprising a microcell layer having specific architecture achieve efficient switching between the open and close optical states and improved optical performance of the open optical state.

### SUMMARY OF THE INVENTION

In an aspect the present invention provides a variable light transmission device (200) comprising a first light transmissive electrode layer (202), a second light transmissive electrode layer (207); and a microcell layer (203). The microcell layer (203) is disposed between the first light transmissive electrode layer (202) and the second light transmissive electrode layer (207). The microcell layer (203) comprises a plurality of microcells (204) and a sealing layer (206). Each microcell of the plurality of microcells (204) includes an electrophoretic medium (209), the electrophoretic medium (209) comprising electrically charged pigment particles (223), a charge control agent, and a non-polar liquid. Each microcell of the plurality of microcells (204) has a microcell opening (205). The sealing layer (206) spans the microcell openings (205) of the plurality of microcells (204). The sealing layer (206) of each microcell has an upper surface and a lower surface, the lower surface being in contact with the electrophoretic medium (209), the upper surface being in contact (i) with the first light transmissive electrode layer (202) or (ii) with an adhesive layer. The adhesive layer is disposed between the first light transmissive electrode layer (202) and the upper surface of the sealing layer (206). Each microcell of the plurality of microcells (204) comprises a microcell bottom layer (210), a protrusion structure (217), a microcell wall (212), and a channel (215). The microcell bottom layer (210) has a microcell bottom inside surface (211), the microcell bottom inside surface (211) consisting of an exposed microcell bottom inside surface (211a) and a microcell bottom inside surface (211b). The protrusion structure (217) has a protrusion base (218), a protrusion surface (221), a protrusion apex (219), a protrusion height (220), and a protrusion volume. The protrusion apex (219) is a point of the protrusion structure having shorter distance from the microcell opening (205) than all other points of the protrusion structure (217). The protrusion height (220) is the distance between the protrusion base (218) and the protrusion apex (219). The protrusion surface (221) is a surface of the protrusion structure (217) that is in contact with the electrophoretic medium (209). The unexposed microcell bottom inside surface (211b) is in contact with the protrusion base (218). The exposed microcell bottom inside surface (211a) is in contact with the electrophoretic medium (209). The microcell wall (212) has a microcell wall inside surface (213) and a microcell wall upper surface (214). The microcell wall inside surface (213) is a surface of the microcell wall (212) of a microcell that is in contact with the electrophoretic medium (209). The microcell wall upper surface (214) is the surface of the microcell wall (212) that is in contact with the sealing layer (206). The channel (215) has a channel height (216h), a channel base, a channel base width, an inner base perimeter, and an outer base perimeter. The channel height (216h) is 50% of the protrusion height (220). The inner base perimeter is the intersection of the microcell wall (212) and the exposed microcell bottom inside surface (211). The outer base perimeter is the intersection of the protrusion base and the exposed microcell bottom inside surface. The channel base width is the smaller distance between a point in the inner base perimeter and a point in the outer base perimeter. The channel (215) has a three-dimensional shape that is defined by a space between the exposed microcell bottom inside surface (211a), the protrusion surface (221), a plane that is parallel to the microcell bottom inside surface (211), the plane having a distance from the microcell bottom inside surface (211) equal to the channel height (216h), and the microcell wall inside surface (213). The protrusion structure has a three-dimensional shape consisting of one geometric solid or two or more geometric solids. The one geometric solid or at least one of the two or more geometric solids is a conoid, wherein the protrusion base is a geometric shape selected from the group consisting of a teardrop, a teardrop having a rounded end, an ellipse with two pointed ends, a lemon shape, a rounded-end lemon shape, a curved polygon, and a curved polygon with rounded vertices, the polygon having from 3 to 6 sides. Application of a first electric field between the first light transmissive electrode layer (202) and the second light transmissive electrode layer (207) via a first waveform causes movement of the electrically charged pigment particles (223) towards the channel (215), resulting in switching of the variable light transmission device (200) to an open optical state. Application of a second electric field between the first light transmissive electrode layer (202) and the second light transmissive electrode layer (207) via a second waveform causes a movement of the electrically charged pigment particles (223) towards the first light transmissive electrode layer (202), wherein the closed optical state has lower percent transparency than the open optical state. The second electric field causes a movement of the electrically charged pigment particles (223) towards the first light transmissive electrode layer (202) with a velocity; the velocity may have a lateral component. The second waveform may comprise at least one positive voltage and at least one negative voltage, the second waveform having a net positive or net negative impulse. The second waveform may comprise an AC waveform, the AC waveform having a duty cycle of from 5% to 45%, or wherein the second waveform comprises a DC-offset waveform, which is formed by a superposition of a DC voltage component and an AC waveform.

In one example, the variable light transmission device of the present invention comprises a microcell having a protrusion structure, the protrusion structure having a three-dimensional shape consisting of one geometric solid, the one geometric solid being a conoid.

The microcell opening (205) of each microcell of the plurality of microcells (204) of the microcell layer (203) is a geometric shape, the geometric shape of the microcell opening (205) may be the same as the geometric shape of the protrusion base of the microcell.

Each microcell of the plurality of microcells (204) may have a length of from 400 micrometers to 800 micrometers and a height of from 20 micrometers to 100 micrometers, and wherein the width of the channel of each microcell of the plurality of microcells (204) is from 10 micrometers to 30 micrometers.

Each microcell of the plurality of microcells of the variable transmission device of the present invention may have a microcell length of from 400 micrometers to 850 micrometers, from 450 micrometers to 800 micrometers, from 500 micrometers to 750 micrometers, or from 600 micrometers to 740 micrometers. Each microcell of the plurality of microcells of the variable transmission device of the present invention may have a microcell height of from 20 micrometers to 100 micrometers, from 20 micrometers to 90 micrometers, from 20 micrometers to 80 micrometers, from 20 micrometers to 60 micrometers, from 20 micrometers to 40 micrometers, from 30 micrometers to 90 micrometers, from 30 micrometers to 80 micrometers, from 30 micrometers to 60 micrometers, from 30 micrometers to 40 micrometers, from 40 micrometers to 80 micrometers, from 40 micrometers to 60 micrometers, from 40 micrometers to 50 micrometers, from 25 micrometers to 40 micrometers, from 50 micrometers to 100 micrometers, or from 50 micrometers to 80 micrometers.

The protrusion height (220) may be from 15 micrometers to 90 micrometers, from 20 micrometers to 90 micrometers, from 20 micrometers to 80 micrometers, from 20 micrometers to 70 micrometers, from 20 micrometers to 50 micrometers, from 20 micrometers to 30 micrometers, from 30 micrometers to 80 micrometers, from 30 micrometers to 70 micrometers, from 30 micrometers to 50 micrometers, from 30 micrometers to 40 micrometers, from 40 micrometers to 90 micrometers, from 40 micrometers to 50 micrometers, from 30 micrometers to 50 micrometers, from 25 micrometers to 35 micrometers, from 50 micrometers to 90 micrometers, or from 50 micrometers to 70 micrometers.

The microcell layer may comprise a set of two adjacent microcells, a first microcell and a second microcell. The first microcell may comprise a first protrusion structure having a first protrusion base, the first protrusion base having a geometric shape of (i) a symmetrical teardrop or (ii) a symmetrical teardrop having a rounded end, the geometric shape of the first protrusion base having an axis, the axis having a direction; the second microcell may comprise a second protrusion structure having a second protrusion base, the second protrusion base having a geometric shape of (iii) a symmetrical curved triangle or (iv) a symmetrical curved triangle with rounded vertices, the geometric shape of the second protrusion base having three axes, each of the three axes having a direction. One of the three axes of the geometric shape of the second protrusion base may be parallel to the axis of the geometric shape of the first protrusion base and having a direction that is the same as the direction of the axis of the geometric shape of the first protrusion base.

The microcell layer may comprise a set of two adjacent microcells, a third microcell and a fourth microcell; the third microcell may comprise a third protrusion structure having a third protrusion base, the third protrusion base having a geometric shape of (i) a symmetrical teardrop or (ii) a symmetrical teardrop having a rounded end, the geometric shape of the third protrusion base having an axis; the fourth microcell may comprise a fourth protrusion structure having a fourth protrusion base, the fourth protrusion base having a geometric shape of (iii) a symmetrical curved triangle or (iv) a symmetrical curved triangle with rounded vertices, the geometric shape of the fourth protrusion base having three axes. One of the three axes of the geometric shape of the fourth protrusion base and the axis of the third protrusion base may form an angle of from 30 to 60 degrees.

The microcell layer may comprise a set of four microcells, a first, second, third, and fourth microcells; the first microcell may comprise a first protrusion structure having a first protrusion base; the second microcell may comprise a second protrusion structure having a second protrusion base, the third microcell comprising a third protrusion structure having a third protrusion base; the fourth microcell may comprise a fourth protrusion structure having a fourth protrusion base; the first microcell is adjacent to the second and third microcells, the second microcell is adjacent to the first, third and fourth microcells, the third microcell is adjacent to the first, second, and fourth microcells, the fourth microcell is adjacent to the second and third microcells; the first protrusion base may have a geometric shape of (i) a symmetrical teardrop or (ii) a symmetrical teardrop having a rounded end, the geometric shape of the first protrusion base having a first axis, the first axis having a first direction; the second protrusion base may have a geometric shape of (iii) a symmetrical teardrop or (iv) a symmetrical teardrop having a rounded end, the geometric shape of the second protrusion base having a second axis, the second axis having a second direction; the third protrusion base may have a geometric shape of (v) a symmetrical curved triangle or (vi) a symmetrical curved triangle with rounded vertices, the geometric shape of the third protrusion base having three axes, each of the three axes having a direction; the fourth protrusion base may have a geometric shape of (vii) a symmetrical curved triangle or (viii) a symmetrical curved triangle with rounded vertices, the geometric shape of the fourth protrusion base having three axes, each of the three axes having a direction; the first axis may be parallel to the second axis, the direction of the first axis being opposite to the direction of the second axis; one of the axes of the geometric shape of the third protrusion base may be parallel to the first and second axes, and having a direction that is the same as the first direction; one of the axes of the geometric shape of the fourth protrusion base may be parallel to the first and second axes and having a direction that is the same as the second direction. The microcell layer may comprise two or more sets of four microcells, each set consisting of the first, second, third, and fourth microcells.

The microcell layer may comprise a set of four microcells, a fifth, sixth, seventh, and eighth microcells; the fifth microcell may comprise a fifth protrusion structure having a fifth protrusion base; the sixth microcell may comprise a sixth protrusion structure having a sixth protrusion base; the seventh microcell may comprise a seventh protrusion structure having a seventh protrusion base; the eighth microcell may comprise an eighth protrusion structure having an eighth protrusion base; the fifth microcell may be adjacent to the sixth and seventh microcells; the sixth microcell may be adjacent to the fifth, seventh, and eighth microcell; the seventh microcell may be adjacent to the fifth, sixth, and eighth microcells; the eighth microcell may be adjacent to the sixth and seventh microcells; the fifth protrusion base may have a geometric shape of (i) a symmetrical teardrop or (ii) a symmetrical teardrop having a rounded end; the geometric shape of the fifth protrusion base may have a fifth axis, the fifth axis having a fifth direction; the sixth protrusion base may have a geometric shape of (iii) a symmetrical teardrop or (iv) a symmetrical teardrop having a rounded end; the geometric shape of the sixth protrusion base may have a sixth axis, the sixth axis having a sixth direction; the seventh protrusion base may have a geometric shape of (v) a symmetrical curved triangle or (vi) a symmetrical curved triangle with rounded vertices; the geometric shape of the seventh protrusion base may have three axes, each of the three axes having a direction; the eighth protrusion base may have a geometric shape of (vii) a symmetrical curved triangle or (viii) a symmetrical curved triangle with rounded vertices; the geometric shape of the eighth protrusion base may have three axes, each of the three axes having a direction; the fifth axis may be parallel to the sixth axis, the direction of the fifth axis being opposite to the direction of the sixth axis; one of the axes of the geometric shape of the seventh protrusion base may be parallel to the fifth and sixth axes and having a direction that is the opposite to the fifth direction; one of the axes of the geometric shape of the eighth protrusion base may be parallel to the fifth and sixth axes and may have a direction that is the same as the fifth direction. The microcell layer may comprise two or more sets of four microcells, each set consisting of the fifth, sixth, seventh, and eighth microcells. The set of microcells may comprise, in addition to the fifth, sixth, seventh, and eighth microcells, a ninth, tenth, eleventh, and twelfth microcells; the ninth microcell may comprise a ninth protrusion structure having a ninth protrusion base; the tenth microcell may comprise a tenth protrusion structure having a tenth protrusion base; the eleventh microcell may comprise a eleventh protrusion structure having a eleventh protrusion base; the twelfth microcell may comprise a twelfth protrusion structure having a twelfth protrusion base; the seventh microcell may be adjacent to the fifth, sixth, eight, and ninth microcells; the eighth microcell may be adjacent to the sixth, seventh, ninth, and tenth microcells; the ninth microcell may be adjacent to the seventh, eight, tenth and eleventh microcells; the tenth microcell may be adjacent to the eighth, ninth, eleventh, and twelfth microcells; the eleventh microcell may be adjacent to the ninth, tenth, and twelfth microcells; the twelfth microcell may be adjacent to the tenth, and eleventh microcells; the ninth protrusion base may have a geometric shape of (i) a symmetrical teardrop or (ii) a symmetrical teardrop having a rounded end, the geometric shape of the ninth protrusion base having a ninth axis, the ninth axis having a ninth direction; the tenth protrusion base may have a geometric shape of (iii) a symmetrical teardrop or (iv) a symmetrical teardrop having a rounded end, the geometric shape of the tenth protrusion base having a tenth axis, the tenth axis having a tenth direction; the eleventh protrusion base may have a geometric shape of (v) a symmetrical curved triangle or (vi) a symmetrical curved triangle with rounded vertices, the geometric shape of the eleventh protrusion base having three axes, each of the three axes having a direction; the twelfth protrusion base may have a geometric shape of (vii) a symmetrical curved triangle or (viii) a symmetrical curved triangle with rounded vertices, the geometric shape of the twelfth protrusion base having three axes, each of the three axes having a direction; the ninth axis may be parallel to the tenth axis, the direction of the ninth axis may be opposite to the direction of the tenth axis, one of the axes of the geometric shape of the eleventh protrusion base may be parallel to the ninth and tenth axes, and having a direction that is the same as the ninth direction; one of the axes of the geometric shape of the twelfth protrusion base may be parallel to the ninth and tenth axes and having a direction that is the same as the tenth direction; the fifth axis and the ninth axis may form an angle of from 30 to 60 degrees. The microcell layer may comprise two or more sets of eight microcells, each set consisting of the fifth, sixth, seventh, eighth, ninth, tenth, eleventh, and twelfth microcells.

The variable light transmission device of the present invention may comprise a microcell having a microcell wall inside surface (213) and a microcell bottom surface (211), wherein the microcell wall inside surface (213) and the microcell bottom surface (211) form an angle (φ), the angle (φ) being from 90 to 120 degrees.

The variable light transmission device of the present invention may comprise (i) an adhesive layer, the adhesive layer being disposed between the first light transmissive electrode layer (202) and the sealing layer (206), (ii) a second adhesive layer, the second adhesive layer being disposed between the microcell layer (203) and the second light transmissive electrode layer (207), or (iii) both the adhesive layer and the second adhesive layer.

The variable light transmission device may comprise a light blocking layer (230) disposed between the microcell wall upper surface (214) and the sealing layer (206); the light blocking layer (230) may comprise light absorbing pigment; the light absorbing pigment of the light blocking layer (230) may have black color.

The variable light transmission device (200) has a first outside surface (250) and a second outside surface (251). The first outside surface (250) is located on a side of the variable light transmission device that is near the first light transmissive electrode layer (202), and the second outside surface (251) is located on a side of the variable light transmission device that is near the second light transmissive electrode layer (207).

The electrophoretic medium may comprise a charge control agent. The content of the charge control agent in the electrophoretic medium of the variable light transmission device may be from 0.1 weight percent to 8 weight percent of charge control agent by weight of the electrophoretic medium. The molecular structure of the charge control agent may include a quaternary ammonium functional group and a non-polar tail. The non-polar liquid of the electrophoretic medium may comprise a material selected from the group consisting of an aliphatic hydrocarbon, a cycloaliphatic hydrocarbon, an aromatic hydrocarbon, a halogenated aliphatic hydrocarbon, a polydimethylsiloxane, or mixture thereof.

### BRIEF DESCRIPTION OF DRAWINGS

FIG. 1A illustrates a two-dimensional shape of a teardrop.

FIG. 1B illustrates a two-dimensional shape of a teardrop having a rounded end.

FIG. 1C illustrates a two-dimensional shape of an ellipse with two pointed ends

FIG. 1D illustrates a two-dimensional shape of a lemon.

FIG. 1E illustrates a two-dimensional shape of a curved triangle.

FIG. 1F illustrates a curved segment consisting of three curved segments.

FIG. 2 illustrates a cylindrical particle in a liquid under the influence of an applied electric field and resulting forces on the particle.

FIGS. 3A, 3B, 3C and 3D illustrate a side view of an example of a portion of a variable light transmission device of the present invention.

FIGS. 4A and 4B illustrate a side view of a microcell in the open optical state and a side view of a microcell in the closed optical state. The electrophoretic medium comprises one type of electrically charged pigment particles.

FIG. 5A is an example of a DC-imbalanced waveform that can be applied on a variable light transmittance device to achieve a closed state; the waveform includes an AC waveform having a duty cycle that is higher than 50%.

FIG. 5B is an example of a DC-imbalanced waveform that can be applied on a variable light transmittance device to achieve a closed state; the waveform is a superposition of a DC voltage component and an AC waveform.

FIG. 6 illustrates the force exerted by an electrically charged pigment particle on the surface of a conical protrusion of the variable light transmission device of the present invention.

FIG. 7 is a side view of a portion of a variable light transmission device having a microcell, the microcell comprising a light blocking layer (230).

FIG. 8 is a side view of a portion of a variable light transmission device having a microcell, the microcell comprising a protrusion structure (217), a microcell wall (212), the microcell wall having a microcell wall inside surface 213 and an microcell bottom surface (211), the microcell wall inside surface (213) and the microcell bottom surface (211) form an angle (φ), the angle (φ) being larger than 90 degrees.

FIGS. 9A, 9B, 9C, and 9D illustrate top views of examples of microcells of variable light transmission devices of the present invention.

FIGS. 10A, 10B illustrate a top view of a set of two microcells of variable light transmission devices of the present invention.

FIGS. 11A, 11B, 11C, 11D, 11E, and 11F illustrate top views of various sets of microcells of a variable light transmission devices of the present invention.

FIG. 12A illustrates a top view of a portion of a variable light transmission device having a plurality of microcells, each of the plurality of microcells having hexagonal inner and outer base perimeters.

FIG. 12B shows a Fraunhofer diffraction pattern formed by an hexagonal aperture of the device, a top view of a portion of which is illustrated in FIG. 12A.

FIG. 13 shows a Fraunhofer diffraction pattern formed by the variable transmission device a top view of a portion of which is illustrated in FIG. 11F.

### DETAILED DESCRIPTION OF THE INVENTION

As used herein, a “variable light transmission device” is a device comprising an electrophoretic medium, wherein the quantity of transmitted light through the device can be controlled by application of electric field across the electrophoretic medium.

“First outside surface of a variable light transmission device” and “second outside surface of a variable light transmission device” are the outside surface of the device that are parallel to the first light transmissive electrode layer and the second light transmissive electrode layer, respectively. The term “outside surface” as used herein, only refers to the main surfaces on the viewing sides of the variable light transmission device, not the smaller surface on the periphery of the device.

“Exposed microcell bottom inside surface” is the part of the microcell bottom inside layer that is in contact with the electrophoretic medium. On the contrary, “unexposed microcell bottom inside surface” is the part of the microcell bottom inside layer that is not in contact with the electrophoretic medium.

“Percent transparency of a variable light transmission device” (% T) at a location of the device is given by Equation 1. Thus, “percent transparency of a variable light transmission device” (% T) at a location of the device is the ratio of the intensity of light that is transmitted through the variable light transmission device and exiting from a location of the second outside surface of the variable transmission device (I) to the intensity of light that enters the variable light transmission device from a location at the first outside surface of the variable light transmission device (Io) times 100; the location of the second outside surface is symmetrical to the location of the first outside surface with respect to a plane, the plane being at equal distance between the first light transmissive electrode layer and the second light transmissive electrode layer.

$$\% T = ( I / Io ) \times 100 \qquad ( Equation 1 )$$

The distance of a point from a plane is the shortest perpendicular distance from the point to the plane.

The distance between two planes in a three-dimensional space is the shortest distance between the planes. It is the shortest distance between any point on one plane and any point on the other plane.

As used herein, the term “conoid” is a three-dimensional shape that has a base, a curved surface, and an apex (point A). The base of the conoid is a two-dimensional shape; the base of the conoid has a surface and a perimeter, the surface of the base being part of a plane P. The perimeter of the base of the conoid is the boundary of the shape of the base; that is, the perimeter encloses the shape of the base. The curved surface connects the perimeter of the base of the conoid to the apex of the conoid. The apex is a pointed tip of the conoid opposite to the base. All the points of the conoid are present in a space that is defined by plane P and a plane R, plane R being parallel to plane P and includes point A (apex). The apex is a point of the conoid that has larger distance to the conoid base than any other point of the conoid. The plane of the conoid is not a circle (as in a typical cone). The protrusion structure of a microcells of a variable light transmission device of the present invention has a three-dimensional shape that consists of one geometric solid or two or more geometric solids, the geometric solid or at least one of the geometric solids of the two or more geometric solids being a conoid as defined above. The base of the conoid is a two-dimensional shape selected from the group consisting of a teardrop, a teardrop having a rounded end, an ellipse with two pointed ends, a lemon shape, a rounded-end lemon shape, a curved polygon, and a curved polygon with rounded vertices. The variable light transmission device of the present invention device may comprise various types of microcells having different protrusion structures and protrusion bases.

A “curved segment” is a portion of a curve that is defined by two points, a starting point and an ending point.

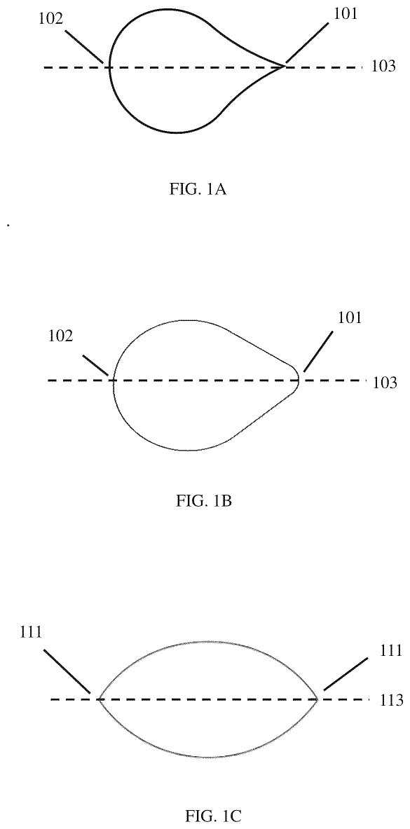

As used herein, a “teardrop shape”, an example of which is illustrated in FIG. 1A, is a two-dimensional shape that comprises various radii of curvature. A teardrop shape comprises two ends, a first end and a second end. The first end is a point on the perimeter of the teardrop shape that has the smallest radius of curvature. The second end is located on the opposite side of the perimeter of the teardrop shape from the first end, the second end having a high radius of curvature. Hereinafter, the first end is referred to as “teardrop tip” (101) and the second end is referred to as “teardrop head point” (102). In one type of teardrop shapes, the teardrop tip is a point on the perimeter of the teardrop shape where two curved segments of the perimeter meet; an abrupt change in the curvature of the perimeter of the teardrop shape is observed at the teardrop tip, as illustrated in the shape of FIG. 1A. In this type of teardrop shapes, the teardrop tip is called “pointed end”, and the teardrop shape is called a teardrop having a pointed end. In another teardrop shape example, the change in the curvature of the perimeter at the teardrop tip is less abrupt than that of the teardrop having a pointed end and the part of the perimeter where the teardrop tip is located is rounded. In this case, the teardrop tip is called “rounded end”, and the teardrop shape is called a teardrop having a rounded end. An example of this type of teardrop shape is illustrated in FIG. 1B. The line that passes by the teardrop tip (101) and the teardrop head point (102) is called teardrop axis (103). The teardrop axis has a direction, the direction of the axis being from the teardrop tip to the teardrop head point. In some examples, the teardrop axis is an axis of symmetry, which means that the axis divides the teardrop shape into two identical halves, the two identical halves being mirror images of each other. In this case, the teardrop shape is a called a “symmetrical teardrop shape” or, synonymously, the “teardrop shape has an axis of symmetry”. The teardrop shapes that are illustrated in FIGS. 1A and 1B are symmetrical teardrop shapes. Hereinafter, the term “teardrop” is assumed to refer to a teardrop having a pointed end, if not specifically referred to as “teardrop having a rounded end”.

As used herein, the term “ellipse with two pointed ends” is a geometric shape that resembles an ellipse having two ends tapering to a point, as opposed to a typical ellipse, where the two ends are smoothly rounded. An example of an ellipse with two pointed ends is illustrated in FIG. 1C. The line that includes the two-pointed ends (111) is called an axis of the ellipse with two pointed ends. In one type of ellipse with two pointed ends, the ellipse axis is an axis of symmetry, which means that the axis divides the ellipse with two pointed ends (111) into two identical halves, the two identical halves being mirror images of each other. Thus, in this type of shape, the ellipse with two pointed ends has an axis of symmetry (113) and the ellipse with two pointed ends of this type is called a “symmetrical ellipse with two pointed ends”.

As used herein, a “lemon shape” is a two-dimensional shape that has a perimeter, the perimeter consisting of a first end, a second end, a first curved segment and a second curved segment. FIG. 1D illustrates a top view of a two-dimensional shape of a lemon shape having a first end (121) and a second end (122). A line that passes through first end and second end is an axis of the lemon shape (123). The curve above the axis in the illustration is the first curved segment; the curved below the axis in the illustration is the second curved segment. In one type of lemon shape, the axis of the lemon shape is an axis of symmetry, which means that the axis divides the lemon shape into two identical halves, the two identical halves being mirror images of each other. The axis 123 of the example of lemon shape of FIG. 1D is an axis of symmetry. Thus, in this type of lemon shape, the lemon shape has an axis of symmetry, and the lemon shape is called a “symmetrical lemon shape”. The example of lemon shape of FIG. 1D is a symmetrical lemon shape. The first curved segment connects the first end with the second end and the second curved segment also connects the first end with the second end. The first curved segment consists of three curved segments, A, B, and C, each of the curved segments A, B, and C having a starting point and an ending point. Starting point of curved segment A is in contact with first end, ending point of curved segment A is in contact with the starting point of curved segment B, the ending point of curved segment B is in contact with the starting point of curved segment C, and the ending point of curved segment C is in contact with the second end. Curved segment A and C are concave, whereas curved segment B is convex. The second curved segment consists of three curved segments, D, E, and F, each of the curved segments D, E, and F having a starting point and an ending point. Starting point of curved segment D is in contact with first end, ending point of curved segment D is in contact with the starting point of curved segment E, the ending point of curved segment E is in contact with the starting point of curved segment F, and the ending point of curved segment F is in contact with the second end. Curved segment D and F are concave, whereas curved segment F is convex. An example of a lemon shape is illustrated in FIG. 1D. In one type of lemon shape, the first end and the second end is the point on the perimeter where the first curved segment meet the second curved segment, and an abrupt change in the curvature of the perimeter of the lemon shape is observed at the teardrop tip, as illustrated in the shape of FIG. 1D. In this case, the first and second end of the shape are called “pointed ends”, and the lemon shape is called lemon shape having pointed ends or pointed end lemon shape. In another type of lemon shape, the change in the curvature of the perimeter at the teardrop tip is less abrupt than that of or pointed end lemon shape and the part of the perimeter where the first and second ends is located is rounded. In this case, the first and second ends of the lemon shape are called rounded ends of the lemon shape, and the lemon shape of this type is called a lemon shape having rounded ends or rounded-end lemon shape. The rounded-end lemon shape can also be described as follows.

A rounded-end lemon shape is a two-dimensional shape that has a perimeter, the perimeter consisting of a first end, a second end, a first curved segment and a second curved segment. A line that passes through first end and second end is an axis of the rounded-end lemon shape. In one type of rounded-end lemon shape, the axis of the rounded-end lemon shape is an axis of symmetry, which means that the axis divides the rounded-end lemon shape into two identical halves, the two identical halves being mirror images of each other. Thus, in this type of lemon shape, the rounded-end lemon shape has an axis of symmetry, and the lemon shape is called a “symmetrical lemon shape”. The first curved segment connects the first end with the second end and the second curved segment also connects the first end with the second end. The first curved segment consists of five curved segments, G, H, I, J, and K, each of the curved segments G, H, I, J, and K having a starting point and an ending point. Starting point of curved segment G is in contact with the first end, ending point of curved segment G is in contact with the starting point of curved segment H, the ending point of curved segment H is in contact with the starting point of curved segment I, the ending point of curved segment I is in contact with the starting point of curved segment J, the ending point of curved segment J is in contact with the starting point of curved segment K, and the ending point of curved segment K is in contact with the second end. Curved segment G, I, and K are convex, whereas curved segments H and J are concave. The second curved segment consists of five curved segments, L, M, N, O, and P, each of the curved segments L, M, N, O, and P having a starting point and an ending point. Starting point of curved segment L is in contact with the first end, ending point of curved segment L is in contact with the starting point of curved segment M, the ending point of curved segment M is in contact with the starting point of curved segment N, the ending point of curved segment N is in contact with the starting point of curved segment O, the ending point of curved segment O is in contact with the starting point of curved segment O, and the ending point of curved segment O is in contact with the second end. Curved segment L, N, and P are convex, whereas curved segments M and O are concave. The difference between a lemon shape and a rounded-end lemon shape is the presence of the convex curved segments G, K, L, and P; these convex curved segments provide the rounding of the first and second ends of the rounded-end lemon shape. Hereinafter, the term referring to a shape of “lemon” is assumed to refer to a lemon shape that does not have rounded ends, unless it is specifically referred to as “rounded-end lemon”. In addition, a lemon shape (not a rounded-end lemon shape) must include two curved segments (connecting the ends), each of the two curved segments consisting of two concave curved segments and one convex curved segment in the order of concave curved segment-convex curved segment-concave curved segment. A rounded-end lemon shape must include two curved segments (connecting the ends), each of the two curved segments consisting of two concave curved segments and three convex curved segment in the order of convex curved segment-concave curved segment-convex curved segment-concave curved segment-convex curved segment.

A “curved polygon”, as used herein, is a polygon, wherein each side of the polygon is a curved segment; the curved polygons disclosed in the present application have from 3 to 6 vertices; also, the curved polygons disclosed in the present application have from 3 to 6 sides. Each side of the curved polygon has a first and a second vertex; each curved segment comprises three smaller curved segments, Q, R, and S curved segments. Each curved segment has a starting point and an ending point. The following description is related to a curved triangle, but the description can be easily perceived to relate to other curved polygons. An example of a curved triangle is illustrated in FIG. 1E. The curved triangle has three sides and three vertices, a first vertex, a second vertex and a third vertex. The starting point of the curved segment Q is in contact with a first vertex of the curved triangle, the ending point of curved segment Q is in contact with the starting point of curved segment R, the ending point of curved segment R is in contact with the starting point of curved segment S, the ending point of curved segment S is in contact with the second vertex of the curved triangle. Curved segments Q and R are concave, and curved segment R is convex. An example of a curved segment that consists of two concave segments (Q and S) and a convex segment R. The other two sides of the curved triangle consist of similar curved segments to form the “curved triangle”. Analogously, all the four sides of a curved square, all four sides of the curved pentagon, etc. consist of similar curved segments. FIG. 1F is an example of a curved segment that consists of three curved segments Q-R-S, as described above.

The curved polygons that are described above comprise vertices where there is an abrupt change of the radius of curvature at the vertices. In another type of curved polygons, the change of the radius of curvature at the vertices is gradual. That is, in this type of curved polygons the vertices are rounded. A “curved polygon with rounded vertices” as used herein, is a polygon, wherein each side of the polygon is a curved segment; the curved polygons disclosed in the present application have from 3 to 6 vertices; also, the curved polygons disclosed in the present application have from 3 to 6 sides. Each side of the curved polygon has a first and a second vertex; each curved segment comprises five smaller curved segments, T, U, V, X, and Y. Each curved segment has a starting point and an ending point. The following description is related to a curved triangle with rounded vertices, but the description can be easily expanded to other curved polygons with rounded vertices. The curved triangle with rounded vertices has three sides and three vertices, a first vertex, a second vertex and a third vertex. The starting point of the curved segment T is in contact with a first vertex of curved triangle with rounded vertices, the ending point of curved segment T is in contact with the starting point of curved segment U, the ending point of curved segment U is in contact with the starting point of curved segment V, the ending point of curved segment V is in contact with the starting point of curved segment X, the ending point of curved segment Y is in contact with the second vertex of the curved triangle with rounded vertices. Curved segments T, V, and Y are convex and curved segments U and X concave. The other two sides of the curved triangle with rounded vertices consist of similar curved segments to form the “curved triangle with rounded vertices”. Analogously, all the four sides of a curved square, all four sides of the curved pentagon, etc. consist of similar curved segments. The difference between a curved triangle and a curved triangle with rounded vertices is the presence of the convex curved segments, such as convex curved segment T and U, which are in contact with the vertices; these convex curved segments provide the rounding of the vertices of the curved triangle.

Assuming the a curved triangle (or curved triangle with rounded vertices) have vertices A, B, and C, a line that passes from (i) vertex A of the curved triangle (or the curved triangle with rounded vertices) and (ii) a point D, point D being on the linear segment that connects vertex B and vertex C, wherein linear segment BD is equal to linear segment DC, is called axis of the curved triangle (or axis curved triangle with rounded vertices). That is, an axis of the curved triangle (or curved triangle with rounded vertices) is a line that passes from a vertex A and the middle of the linear segment that connects the other two vertices. The curved triangle (or curved triangle with rounded vertices) have 3 axes. Each of the 3 axes may be an axis of symmetry of the curved triangle (or of the curved triangle with rounded vertices), which means that axis divides the teardrop shape into two identical halves, the two identical halves being mirror images of each other. In the case where the 3 axes are axis of symmetry, the curved triangle (or the curved triangle with rounded vertices) is “symmetrical curved triangle” (or “symmetrical curved triangle with rounded vertices”). Each axis of the curved triangle (or curved triangle with rounded vertices) has a direction. The direction of each axis is from a vertex of the curved triangle (or curved triangle with rounded vertices) to a point located in the middle of the linear segment that connects the other two vertices.

Assuming the a curved square (or curved square with rounded vertices) have vertices A, B, C, and D, where vertices A, B, C, and D form sides AB, BC, CD, and DA, a line that passes from (i) a point E, point E being on the linear segment AB that connects vertex A and vertex B, wherein linear segment AE is equal to linear segment EB, and (ii) a point F, point F being on the linear segment CD that connects vertex C and vertex D, wherein linear segment CF is equal to linear segment FD, is called axis of the curved square (or axis of the curved square with rounded vertices). The curved square (or curved square with rounded vertices) have 2 such axes. Each of the 2 axes may be an axis of symmetry of the curved square (or the curved square with rounded vertices), which means that axis divides the curved square (or the curved square with rounded vertices) into two identical halves, the two identical halves being mirror images of each other.

Assuming that the curved pentagon (or curved pentagon with rounded vertices) have vertices A, B, C, D, and E where vertices A, B, C, D, and E form sequential sides AB, BC, CD, DE, and DA, a line that passes from (i) a vertex A of the curved pentagon (or the curved pentagon with rounded vertices), and (ii) a point F, point F being on the linear segment CD that connects vertex C and vertex D, wherein linear segment CF is equal to linear segment FD, is called axis of the curved pentagon (or axis of the curved pentagon with rounded vertices). The curved pentagon (or the curved pentagon with rounded vertices) have 5 such axes. Each of the 5 axes may be an axis of symmetry of the curved pentagon (or the curved pentagon with rounded vertices), which means that axis divides the curved pentagon (or the curved pentagon with rounded vertices) into two identical halves, the two identical halves being mirror images of each other. Each axis of the curved pentagon (or curved pentagon with rounded vertices) has a direction. The direction of each axis is from a vertex (A) of the curved pentagon (or curved pentagon with rounded vertices) to a point (F) located in the middle of the linear segment that connects the two vertices CD.

Assuming that the curved hexagon (or curved hexagon with rounded vertices) have vertices A, B, C, D, E, and F where vertices A, B, C, D, E, and F form sequential sides AB, BC, CD, DE, DF, and FA, a line that passes from (i)) a point G, point G being on the linear segment AB that connects vertex A and vertex B, wherein linear segment AG is equal to linear segment GB, and (ii) a point H, point H being on the linear segment DE that connects vertex D and vertex E, wherein linear segment CD is equal to linear segment DE, is called axis of the curved hexagon (or axis of the curved hexagon with rounded vertices). The curved hexagon (or the curved hexagon with rounded vertices) have 3 such axes. Each of the 3 axes may be an axis of symmetry of the curved hexagon (or the curved hexagon with rounded vertices), which means that axis divides the curved hexagon (or the curved hexagon with rounded vertices) into two identical halves, the two identical halves being mirror images of each other.

The term “electrically charged pigment particles” (223) may refer to electrically charged pigment particles that do not have any polymeric material on the surface of the pigment particles. The term “electrically charged pigment particles” may also refer to pigment particles that have a polymeric material on the surface of the pigment particles. A synonymous term is “electrophoretic particles”.

A “microcell wall inside surface” (213) is the surface of the microcell wall that is in contact with the electrophoretic medium of the microcell.

A “microcell wall upper surface” (214) is the surface of the microcell wall that is in contact with the sealing layer of the microcell. In the case that there is a light blocking layer on the microcell wall upper surface, the light blocking layer is disposed between the microcell wall upper surface and the sealing layer.

“Length of a microcell” is the longest distance between any point of the microcell opening to any other point of the microcell opening.

“Channel base width” is the smallest distance between the inner base perimeter and outer base perimeter of the channel of a microcell.

Two microcells, microcell A and microcell B, are “adjacent microcells” where at least part of the microcell wall of microcell A is part of the microcell wall of microcell B.

The term “DC-balanced waveform” or “DC-balanced driving waveform” applied to a pixel is a driving waveform where the driving voltage applied to the pixel is substantially zero when integrated over the period of the application of the entire waveform. The DC balance can be achieved by having each stage of the waveform balanced, that is, a first positive voltage will be chosen such that integrating over the subsequent negative voltage results in zero or substantially zero. If the waveform is not DC-balanced, it is referred to as “DC-imbalanced waveform” or “DC-imbalanced driving waveform”. The driving waveform applied to a pixel may have a portion that is DC-imbalanced and at least one additional pulse of the opposite impulse to ensure that the overall waveform applied to a pixel is DC-balanced. This additional pulse may be applied before the DC-imbalanced portion of the waveform (pre-pulse). Typical examples of DC-imbalanced waveforms include (a) a square or sinusoidal AC waveform having a duty cycle of less (or more) than 50%, and (b) square or sinusoidal AC waveform that has a DC offset.

The term “impulse” is the integral of voltage with respect to time. That is, for a waveform pulse having a voltage V applied for time t, the impulse is V×t. The impulse can be positive, if the polarity of voltage V is positive, or negative, if the polarity of voltage V is negative.

The term “net positive impulse” of a waveform means that negatively electrically charged pigment particles will be attracted to and will move towards the first light transmissive electrode layer during the application of the waveform.

The term “lateral component of velocity” in relation to the movement of electrically charged pigment particles in a microcell of the variable light transmission device of the present invention is the velocity in the horizontal direction. For this definition, we assume that the velocity of the electrically charged particles is a vector resulting from the vector addition of the velocity in the horizontal direction (Vh), and the velocity in the vertical direction (Vv), and that the vertical direction in the case of the movement of the electrically charged pigment particles inside an electrophoretic microcell is the direction from the first light transmissive electrode layer to the second light transmissive electrode layer or form the second light transmissive electrode layer to the first light transmissive electrode layer. In the same system, the horizontal direction of the movement of the electrically charged pigment particles inside an electrophoretic microcell is the direction from one side of the microcell wall to the other side of the microcell wall, this direction being parallel to the first light transmissive electrode layer. Thus, the statement “the velocity of the electrically charged pigment particles has a lateral component” means that the magnitude of the velocity in the horizontal direction is larger than zero.

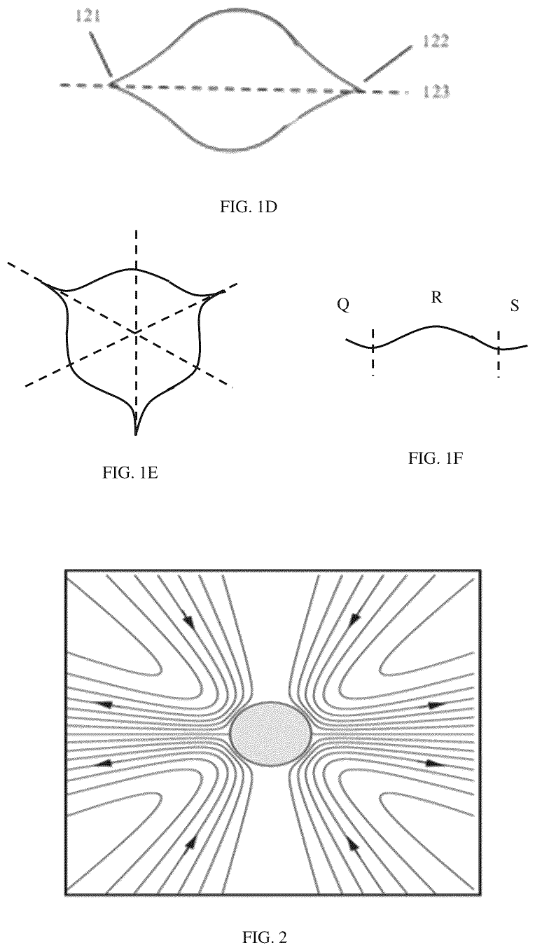

The phenomenon of Induced-Charge-Electro-Osmosis (ICEO) can be utilized to move polarizable particles, such as pigment particles, which are present in an electrophoretic medium, laterally. That is, the polarizable particles can move parallel to the electrode layers that sandwich the electrophoretic medium. In the presence of an electric field, a particle may experience a force, which is caused by polarization of the particle (or by polarization of an adsorbed conductive coating on the particle surface, or of the electrical double layer around the particle). This force may result in a perturbation in the flow of mobile charge, such as ions or charged micelles, in the electrophoretic medium, as shown in FIG. 2 for a cylindrical particle 101 surrounded by the liquid of the electrophoretic medium in the applied electric field. This figure is reproduced by the article of Bazant and Squires, J. Fluid Mech., 2004, 509, 217-252.

A perfectly symmetrical, spherical particle would experience no net force, but less symmetrical particles would experience forces having a component perpendicular to the direction of the applied field. The cooperative flows, which are created by a swarm of particles each experiencing such forces, can lead to “swirling” of an electrophoretic medium containing multiple particles. The maximum velocity u of this swirling for a particular particle, according to the theory advanced in the article by Bazant and Squires, would be given approximately by Expression 1.

$$u ∝ \frac{ε {RE}^{2}}{η ( 1 + {ω}^{2} {τ}^{2} )} \qquad ( Expression 1 )$$

In Expression 1, E is the field strength, ε is the dielectric constant of the solvent, η is the viscosity of the electrophoretic fluid, ω is the applied sinusoidal AC frequency, and τ is the time scale for building up a screening charge layer by motion of solvent-borne charges around charge. The time scale t is given by Equation 3.

$$τ = \frac{{λ}_{D} R}{D} \qquad ( Equation 3 )$$

In Equation 3, λ_{D} is the Debye screening length, R is the particle radius, and D is the diffusion constant of charge carriers in the fluid.

According to Expression 1, as the frequency is raised, the value of ω² τ² increases, and the maximum velocity of induced-charge flows decreases. Furthermore, for values of ω²τ² that are significantly larger than 1, the maximum swirling velocity is proportional to the square of the ratio E/ω. Induced-charge flows occur in the same direction regardless of the polarity of the applied electric field and can thus be driven by alternating fields.

When the electrophoretic medium is contained within a microcell, as is preferred in electrophoretic displays, the geometries of the induced flows are affected by the shape of the particular microcell used. For example, in the simplest case of two parallel electrodes, it was shown that, using an appropriate electric field strength and AC frequency, the flow can adopt a roll structure with periodic spacing that corresponds to the width of the gap between the electrodes.

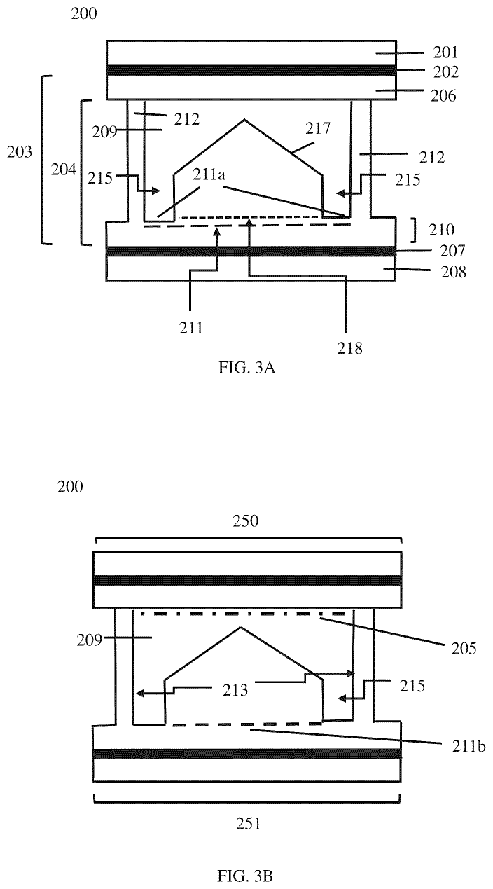

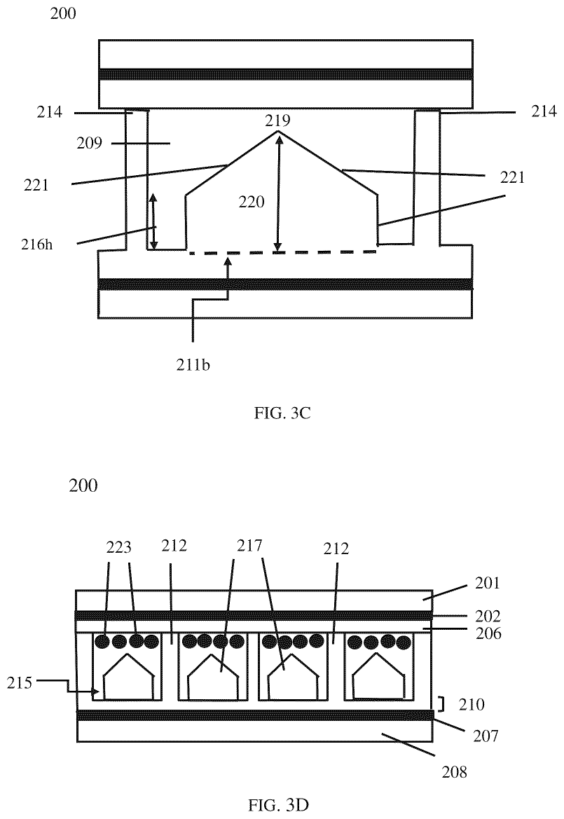

The inventors of the present invention used complex microcell structures that are formed by an embossing method to make variable light transmission devices. In one example, the embossed structure includes a protrusion structure on the bottom of each microcell. FIGS. 3A, 3B, and 3C illustrate an example of a variable light transmission device according to the present invention, wherein the protrusion structure of the variable light transmission device is a conoid. A conoid is a geometric solid that is similar to a cone. The protrusion structure can direct the electrophoretic flow of particles into a channel (215) to achieve the open optical state. The electrically charged pigment particles would move towards the channel, if the electric field applied across the electrophoretic medium has the appropriate polarity in relation to the polarity of the electrically charged pigment particles. For example, the electrically charged pigment particles will move towards the channel, if the electrically charged pigment particles are positively charged and the applied voltage via the light transmissive electrodes results in negative polarity on the second light transmissive electrode. The same movement will take place if the electrically charged pigment particles are negatively charged and the applied voltage via the light transmissive electrodes results in positive polarity on the second light transmissive electrode. FIGS. 3A, 3B, and 3C illustrate a cross-section (not to scale) of a portion of a variable light transmission device that shows only one microcell of the plurality of microcells of the device. All three FIGS. 3A, 3B, 3C are identical in terms of the device structure that is illustrated, but different parts of the device are identified on each of the figures. That is, the figure of FIG. 3A is repeated in FIG. 3B and in FIG. 3C to facilitate the identification of the various parts and components of the device. These figures illustrate only a portion of the display (not in scale), showing only one microcell. In addition, in FIGS. 3A, 3B, and 3C, the protrusion apex is shown to be a point, which, when a vertical line from the apex is drawn to the microcell bottom inside surface, the vertical line is on the center, or close to the center of the microcell bottom inside surface. However, this may not be generally true.

The portion of the variable light transmission device 200 of FIGS. 3A, 3B, and 3C comprises a microcell layer comprising a plurality of microcells and a sealing layer (206). The variable light transmission device may comprise first light transmissive substrate 201, first light transmissive electrode layer 202, a microcell layer 203 comprising a plurality or microcells 204 and a sealing layer 206, second light transmissive electrode layer 207, and second light transmissive substrate 208. Each microcell of the plurality of microcells 204 comprises an electrophoretic medium 209 including electrically charged pigment particles and a non-polar liquid. The components of the electrophoretic medium (electrically charged pigment particles and non-polar liquid) are not shown in FIGS. 3A, 3B, and 3C. Each microcell of the plurality of microcells 204 has a microcell opening 205, the sealing layer 206 spanning the microcell openings 205 of the plurality of microcells 204. Each microcell of the plurality of microcells 204 comprises microcell bottom layer 210, protrusion structure 217, microcell wall 212, and channel 215. Microcell bottom layer 210 has microcell bottom inside surface 211, the microcell bottom inside surface 211 that comprises exposed microcell bottom inside surface 211a and unexposed microcell bottom inside surface 211b. Unexposed microcell bottom surface 211b is in contact with the protrusion base 218.

In the example of FIGS. 3A, 3B, and 3C, the protrusion structure 217 is a conoid. The surface of the conoid in this example is complex, because the slope of the protrusion structure surface near the protrusion base has different slope than that of the protrusion surface closer to the apex. The protrusion structure includes electrophoretic medium 209. Protrusion structure 217 has a protrusion base 218, a protrusion surface 221, a protrusion apex 219, and a protrusion height 220. The protrusion apex 219 is a point of the protrusion structure 217 having shorter distance from microcell opening 205 than all other points of the protrusion structure 217. The protrusion height 220 is the distance between the protrusion base 218 and the protrusion apex 219. A microcell layer comprising a plurality of microcells 204 having protrusion structure 217 may be manufactured by embossing thermoplastic or thermoset precursor layer using a pre-patterned male mold, followed by releasing the mold. The precursor layer may be hardened by radiation, cooling, solvent evaporation, or other means during or after the embossing step.

Microcell wall 212 has a microcell wall inside surface 213 and a microcell wall upper surface 214. The microcell wall inside surface 213 is in contact with electrophoretic medium 209. The microcell wall upper surface 214 is a surface of microcell wall 212 of a microcell that is in contact with sealing layer 206. Furthermore, FIG. 3B shows first outside surface 250 being located on a side of the variable light transmission device that is near the first light transmissive electrode layer (202), and second outside surface (251) being located on a side of the variable light transmission device that is near the second light transmissive electrode layer (207).

Channel 215 is defined as the volume between exposed microcell bottom inside surface 211a, microcell wall inside surface 213, and protrusion surface 221, the microcell wall inside surface (213) and a plane that is parallel to the microcell bottom inside surface (211), the plane having a distance from the microcell bottom inside surface (211) equal to the channel height (216h). This definition shows that the volume of the concavity is also part of the channel. Channel height 216h is 50% of the protrusion height 220. Channel width is the smallest distance between the inner base perimeter and outer base perimeter of a channel. The inner base perimeter of the channel is the same as the perimeter of the protrusion base. The outer base perimeter of the channel may have a two-dimensional shape that is the same in type as the two-dimensional shape of the perimeters of the protrusion base.

The variable light transmission device of FIG. 3D is similar to that illustrated by FIGS. 3A, 3B, and 3C, but shows a larger portion of the device that includes four microcells. Each microcell of the plurality of microcells comprises an electrophoretic medium including electrically charged pigment particles 223 and a non-polar liquid. Each microcell of the plurality of microcells 204 has a microcell opening, the sealing layer 206 spanning the microcell openings of the plurality of microcells. Each microcell of the plurality of microcells comprises microcell bottom layer 210, protrusion structure 217, microcell wall 212, and channel 215. The variable light transmission device illustrated in FIG. 3D is in the closed optical state.

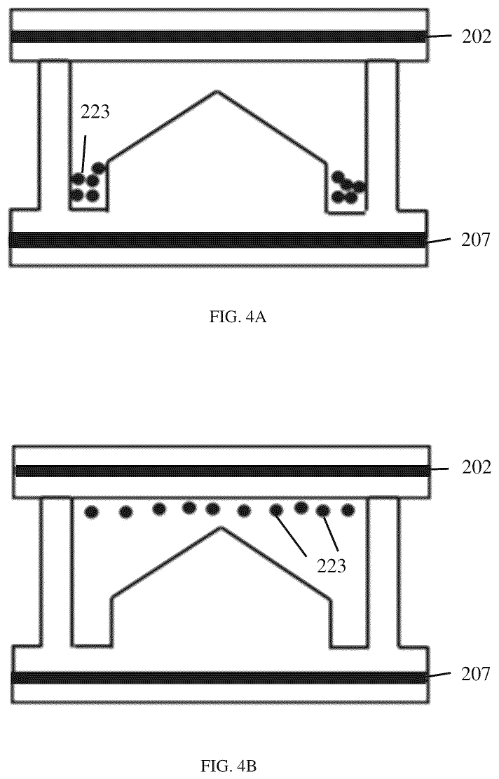

When a first electric field is applied between the first light transmissive electrode layer 202 and the second light transmissive electrode layer 207 via a first waveform, movement of the electrically charged pigment particles 223 towards the channel is caused when the polarity of the electrically charged pigment particles 223 and the voltage polarity of the second light transmissive electrode layer are opposite to each other. If the polarity of the electrically charged pigment particles 223 and the voltage polarity of the second light transmissive electrode layer are opposite to each other, the electrically charged pigment particles 223 will be attracted by the second light transmissive electrode, and the variable light transmission device will switch to an open optical state, the open optical state having higher percent transparency than the closed optical state. The open optical state is illustrated in FIG. 4A, where electrically charged pigment particles 223 are represented by black filled circles. In this example, the electrophoretic medium comprises one type of electrically charged pigment particles 223. In the open optical state, the electrically charged pigment particles 223 are present in the channel of the microcell. Thus, in the open optical state, light passing through the variable light transmission device from a location adjacent to the channel will be obstructed and the variable light transmission device will appear opaque adjacent to the channel, whereas the variable light transmission device will be light transmissive at other locations.

Application of a second electric field between the first light transmissive electrode layer 202 and the second light transmissive electrode layer 207 via a second waveform causes a movement of the electrically charged pigment particles 223 towards the first light transmissive electrode layer 202 with a velocity. This leads to the closed optical state, which is shown in FIG. 4B. The velocity has a lateral component. In the absence of a lateral component of the velocity, the closed optical state will not take place, because the electrically charged pigment particles 223 will move from the channel of the open state towards the first light transmissive electrode layer 202, but these electrically charged pigment particles 223 will occupy an area near the perimeter of a microcell at the vicinity of the sealing layer 206. That is, electrically charged pigment particles 223 will not be spread all across the surface of the first light transmissive electrode layer 202. Thus, the closed optical state will not be effectively formed, because the closed optical state will have relatively high light transmittance.

The above indicates that it is somewhat easier to achieve a transition from the closed optical state to the open optical state, because the slope of the protrusion structure (for example, the cone of FIGS. 4A and 4B) will impart a lateral component to the velocity of the electrically charged pigment particles when they strike the protrusion surface of the protrusion structure during their movement towards second light transmissive electrode layer.

The variable light transmission device may be switched to an open optical state by applying a first electric field between the first light transmissive electrode layer and the second light transmissive electrode layer via a first waveform to cause movement of the first type of electrically charged pigment particles towards the channel, resulting in the switching of the variable light transmission device to an open optical state, the first type of electrically charged pigment particles in the open optical state being located inside the channel. The variable light transmission device may be switched to an open optical state by applying a second electric field between the first light transmissive electrode layer and the second light transmissive electrode layer via a second waveform to cause a movement of the first type of electrically charged pigment particles towards the first light transmissive electrode layer with a velocity, the velocity having a lateral component, and leading to a closed optical state, the second waveform comprising a series of at least two positive and negative pulses having a net positive or net negative impulse, wherein the closed optical state has lower percent transparency than the open optical state.

The second waveform may be DC-imbalanced. The second waveform may comprise at least one positive voltage and at least one negative voltage, the second waveform having a net positive or a net negative impulse. The choice of a net positive or net negative impulse depends on the polarity of the electrically charged pigment particles to be moved to the location of the electrophoretic medium near the sealing layer. Specifically, if the closed state involves movement of the first type of electrically charged pigment particles that are negatively charged, a net positive impulse is required to move those particles from the channel towards the first light transmissive electrode layer. In other words, this movement requires that the net result of the applied voltage be an attraction of the negatively charged particles by a positive voltage of the first light transmissive electrode layer in relation to the second light transmissive electrode layer. On the contrary, if the closed state involves movement of the first type of electrically charged pigment particles that are positively charged, a net negative impulse is required to move the electrically charged pigment particles from the channel near the second light transmissive electrode layer 207 towards the first light transmissive electrode layer.

A second electric field that is applied between the two light transmissive electrode layers via a second waveform achieves a closed optical state.

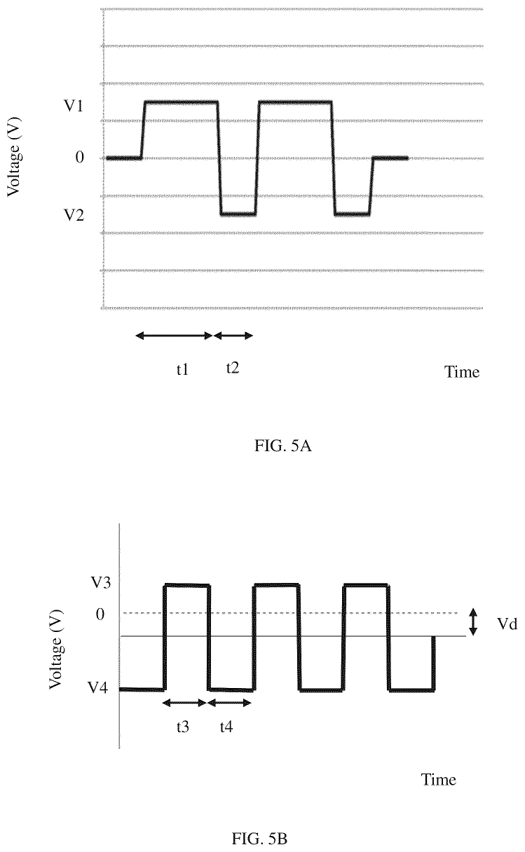

The second waveform may comprise an AC waveform, having a duty cycle different from 50%. An example of the second waveform is illustrated in FIG. 5A.

The AC waveform may have a positive or negative DC bias. DC bias may be achieved by controlling the duty cycle of the waveform. The duty cycle for a positively DC biased waveform is higher than 50%. The duty cycle of a positively DC biased waveform may be higher than 55%, higher than 60%, or higher than 65%. The duty cycle for a positively DC biased waveform may be from 55% to 95%, from 58% to 90%, from 60% to 88%, from 65% to 85%, or from 70% to 80%. Analogously, the duty cycle for a negatively DC biased waveform is lower than 50%. The duty cycle for a negatively DC biased waveform may be lower than 45%, lower than 40%, or lower than 35%. The duty cycle for a negatively DC biased waveform may be from 5% to 45%, from 8% to 40%, from 10% to 38%, from 15% to 35%, or from 20% to 30%.

The waveform illustrated in the example of FIG. 5A comprises an AC square waveform having two or more cycles. Each cycle may comprise a first pulse of amplitude V1 applied for time period t1 and a second pulse of amplitude V2 applied for time period t2, wherein V1 is positive and V2 is negative, and wherein t1 is larger than t2. In the case that the amplitude of V1 is equal to the amplitude of V2 (|V1|=|V2|), a DC bias is achieved by the difference in the time periods. In the case of the example of FIG. 5A, there is a positive DC bias, because the positive voltage V1 is applied for a longer time period (t1) than that of the negative voltage V2 (t2). Positive DC bias means that, if the electrically charged pigment particles of the variable light transmission device are negatively charged, the electrically charged pigment particles will move towards the first light transmissive electrode layer of the device. The duty cycle of the waveform can be calculated by Equation 4.

Duty Cycle=100×(V1·t1)/[(V1·t2)+(V2·t2)] Equation 4

In the waveform example of FIG. 5A, the amplitude of V1 can be equal to the amplitude V2 (|V1|=|V2|), but, in general, the amplitudes V1 and V2 may be different from each other.

The example of the driving waveform of FIG. 5A is DC-imbalanced. However, one or more additional pulses may be included in the waveform of FIG. 5A of the opposite impulse, which can ensure that the overall waveform applied on a pixel is DC-balanced. This additional pulse (or additional pulses) may be applied before the DC-imbalanced waveform (pre-pulse). Also, the example of the waveform of FIG. 5A is a square AC waveform. Other examples of AC waveforms that can be used include sinusoidal waveforms, trigonal waveforms, and sawtooth waveforms.

The AC waveform may have an amplitude of from 10V to 200V and a frequency of from 0.1 to 6000 Hz. The AC waveform may have an amplitude of from 15V to 180V, from 20V to 160V, from 25V to 150V, or from 30V to 140V. The AC waveform may have a frequency of from 0.5 Hz to 5000 Hz, from 1 Hz to 4000 Hz, from 5 Hz to 3000 Hz, from 10 Hz to 2000 Hz, from 15 Hz to 1000 Hz, from 20 Hz to 800 Hz, or from 25 to 600 Hz. The ratio of the frequency of the AC waveform to the weight percent content of the charge control agent by weight of the electrophoretic medium may be from 400 Hz to 2000 Hz.

The second waveform may comprise a waveform that is formed by a superposition of a DC voltage component and an AC waveform. An example of the second waveform is illustrated in FIG. 5B.

The waveform of FIG. 5B has a net negative impulse because of a DC offset (Vd). Although the period of time (t3) of the application of positive pulse is equal to the period of time (t4) of the application of negative pulse, a DC bias is achieved by the difference in the amplitudes of the pulses. Specifically, amplitude V3 of the positive pulse is smaller than amplitude V4 of the negative pulse. This is caused by the DC voltage component Vd of the waveform. That is, the waveform illustrated in FIG. 5B has a DC offset.

The example of the driving waveform of FIG. 5B is DC-imbalanced. However, one or more additional pulses may be included in the waveform of FIG. 5B of the opposite impulse, which can ensure that the overall waveform applied on a pixel is DC-balanced. This additional pulse (or additional pulses) may be applied before the DC-imbalanced waveform (pre-pulse). Also, the example of the waveform of FIG. 5B is a square AC waveform. Other examples of AC waveforms that may be used include a sinusoidal waveform, a trigonal waveform, and a sawtooth waveform.

The AC waveform may have an amplitude of from 10V to 200V and a frequency of from 0.1 to 6000 Hz. The AC waveform may have an amplitude of from 15V to 180V, from 20V to 160V, from 25V to 150V, or from 30V to 140V. The AC waveform may have a frequency of from 0.5 Hz to 5000 Hz, from 1 Hz to 4000 Hz, from 5 Hz to 3000 Hz, from 10 Hz to 2000 Hz, from 15 Hz to 1000 Hz, from 20 Hz to 800 Hz, or from 25 to 600 Hz. The ratio of the frequency of the AC waveform to the weight percent content of the charge control agent by weight of the electrophoretic medium may be from 400 Hz to 2000 Hz.

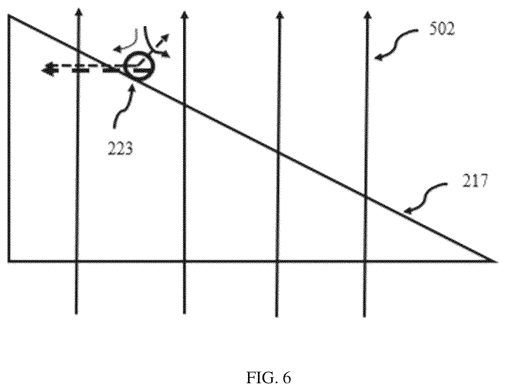

In a case when the ICEO-induced motion of the electrically charged pigment particles is relatively low, the protrusion structure of the microcell contributes to an effective operation of the variable transmission device, even if the device is driven using a DC-balanced AC waveform. In the example of the protrusion structure being a cone, any electrically charged pigment particles that are located at the surface of the cone will experience a net force that will move them towards the apex of the cone, as shown in FIG. 6. FIG. 6 shows electrically charged pigment particle 223 in contact with protrusion structure 217 (cone) in an electric field 502. In this case, the ICEO flows are illustrated by the curved arrows, being more constrained on the “uphill” side of the cone than the “downhill” side. This imparts a force to the particle shown by the dotted horizontal arrow. There will be an opposing force perpendicular to the cone, forcing the particle towards the apex of the cone. With an appropriate choice of AC fields and frequencies, the particles can be moved out of the channel region and up the sides of the cone in this way.

One problem encountered in open optical states of variable light transmission devices, where light-absorbing electrically charged pigment particles are located in only a portion of each microcell (such as in channel), is diffraction patterns that are observable within the field of vision. Such diffraction patterns, known as Fraunhofer diffraction patterns, can be disturbing to a viewer and are formed when light from a small object such as a light source in a dark ambient environment or when light from specular reflections of the sun in a bright ambient environment passes through the variable light transmission device in the open optical state.

The microcells of the variable light transmission device of the present invention (200) may also comprise a light blocking layer 230, as shown in FIG. 7. Light blocking layer 230 is disposed between the microcell upper surface and sealing layer 206. Light blocking layer 230 may comprise a light absorbing pigment. The light absorbing pigment of the light blocking layer may have black color. The inventors of the present invention found that light blocking layer 230 contributes to an improved closed state by increasing the opacity of the device that may be caused by a partially light transmissive wall material. Light blocking layer 230 may be electrically conductive, which may facilitate the switching of the device.

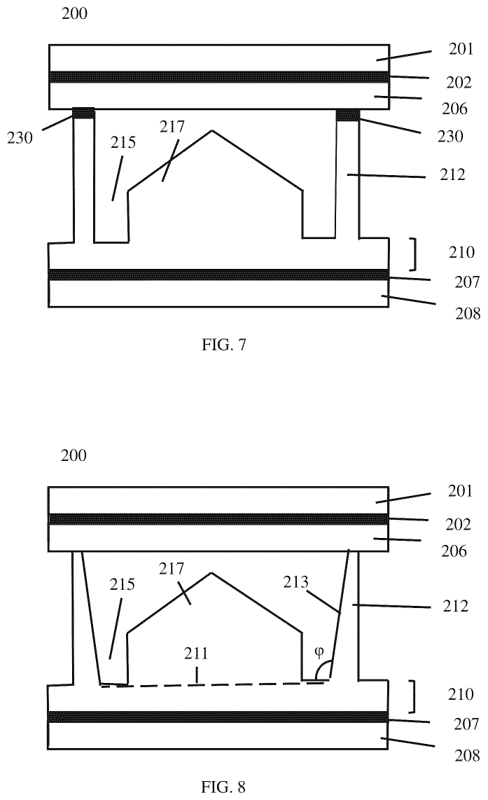

FIG. 8 also illustrates a variable light transmission device of the present invention (560) comprising light transmissive substrate 201, first light transmissive electrode layer 202, microcell layer comprising a plurality of microcells and a sealing layer 206 (herein only one microcell of the plurality of microcells is shown), second light transmissive layer 207, and second light transmissive substrate 208. The microcell comprises microcell wall 212, channel 215, protrusion structure 217, and microcell bottom 210 layer. In the microcell of the variable light transmission device of FIG. 8, the microcell inside wall surface (213) forms an angle (φ) with microcell bottom inside surface (211), the angle being larger than 90 degrees. The inventors of the present invention found that such a structure significantly facilitates the embossing process for the making of the plurality of microcells, by enabling smooth removal of the embossing tool that does not damage the microcell wall. Angle φ may be from 90 to 120 degrees, 93 to 117 degrees, 95 to 115 degrees, 98 to 118 degrees, or 100 to 115 degrees.

As mentioned above, the variable light transmission device of the present invention comprises microcells having a protrusion structure. The protrusion structure has a three-dimensional shape consisting of one geometric solid or two or more geometric solids, the one geometric solid or at least one of the two or more geometric solids being a conoid. The protrusion base is a geometric shape selected from the group consisting of a teardrop, a teardrop having a rounded end, an ellipse with two pointed ends, a lemon shape, a rounded-end lemon shape, a curved polygon, and a curved polygon with rounded vertices, the polygon having from 3 to 6 sides.

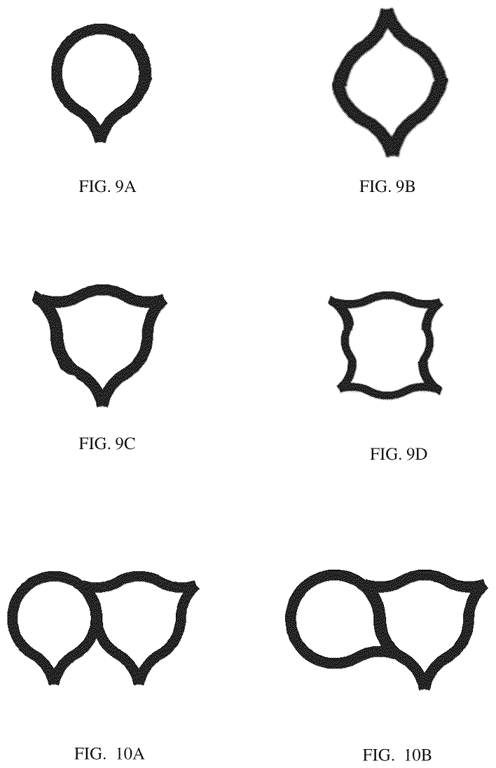

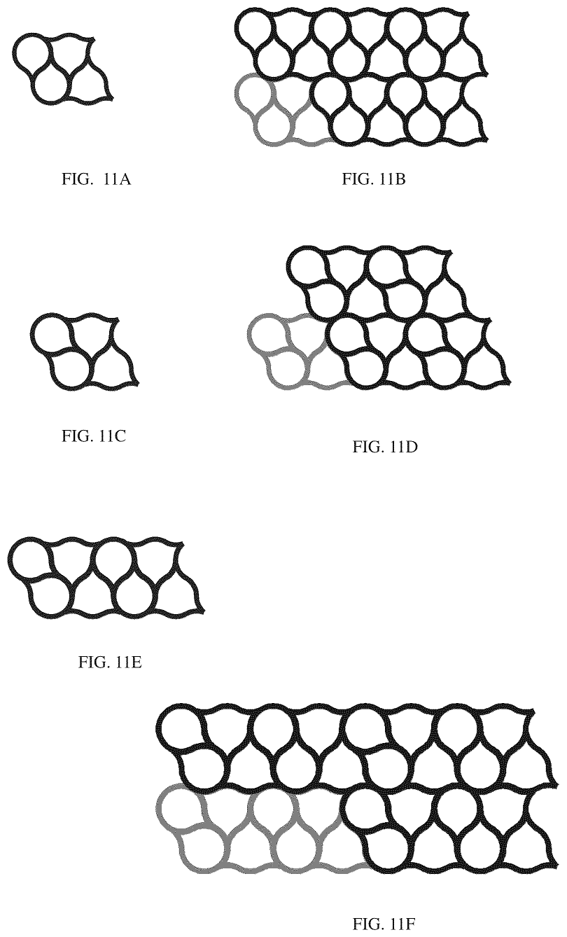

A top view of a microcell having a protrusion base, the geometric shape of which is a teardrop, is illustrated in FIG. 9A. A top view of a microcell having a protrusion base, the geometric shape of which is a lemon shape, is illustrated in FIG. 9B. A top view of a microcell having a protrusion base, the geometric shape of which is a curved triangle, is illustrated in FIG. 9C. A top view of a microcell having a protrusion base, the geometric shape of which is a curved square, is illustrated in FIG. 9D. The thick dark parts of FIGS. 9A, 9B, 9C, and 9D represent the microcell channels of the microcells. As mentioned above, the inner base perimeter of the channel is also the perimeter of the protrusion base. The thick dark parts of FIGS. 10A, 10B, and 11A-11F also represent the microcell channels of the microcells.

The microcell layer of the variable light transmission device of the present invention may comprise a set of two adjacent microcells, a first microcell and a second microcell, as illustrated in FIG. 10A. The first microcell comprises a first protrusion structure having a first protrusion base, the first protrusion base having a geometric shape of a symmetrical teardrop having an axis, the axis having a direction. The second microcell comprising a second protrusion structure having a second protrusion base, the second protrusion base having a geometric shape of a symmetrical curved triangle having three axes, each of the three axes having a direction. In this example, one of the three axes of the geometric shape of the curved triangle is parallel to the axis of the teardrop and having a direction that is the same as the direction of the axis of the teardrop.

Another example of a set of two adjacent microcells, a third microcell and a fourth microcell is illustrated in FIG. 10B. The third microcell comprises a third protrusion structure having a third protrusion base, the third protrusion base having a geometric shape of a symmetrical teardrop having an axis; the fourth microcell comprises a fourth protrusion structure having a fourth protrusion base; the fourth protrusion base has a geometric shape of a symmetrical curved triangle having three axes. In this example, one of the three axes of the symmetrical curved triangle and the axis of the teardrop form an angle of from 30 to 60 degrees.

Another example of a set of four adjacent microcells, a first, second, third, and fourth microcells is illustrated in FIG. 11A. The first microcell comprises a first protrusion structure having a first protrusion base; the second microcell comprises a second protrusion structure having a second protrusion base; the third microcell comprises a third protrusion structure having a third protrusion base; the fourth microcell comprises a fourth protrusion structure having a fourth protrusion base; the first microcell is adjacent to the second and third microcells; the second microcell is adjacent to the first, third and fourth microcells; the third microcell is adjacent to the first, second, and fourth microcells; the fourth microcell is adjacent to the second and third microcells. The first protrusion base has a geometric shape of a symmetrical teardrop having a first axis, the first axis having a first direction. The second protrusion base has a geometric shape of a symmetrical teardrop having a second axis, the second axis having a second direction. The third protrusion base has a geometric shape of a symmetrical curved triangle having three axes, each of the three axes having a direction. The fourth protrusion base has a geometric shape of a symmetrical curved triangle having three axes, each of the three axes having a direction. In this example the first axis is parallel to the second axis, the direction of the first axis being opposite to the direction of the second axis; one of the axes of the geometric shape of the third protrusion base is parallel to the first and second axes and has a direction that is the same as the first direction; one of the axes of the geometric shape of the fourth protrusion base is parallel to the first and second axes and has a direction that is the same as the second direction. The microcell layer may comprise multiple sets of the first, second, third, and fourth microcells. FIG. 11B illustrates a top view of a portion of an example microcell layer that comprises six sets of the first, second, third, and fourth microcells.

Another example of a set of four adjacent microcells, a fifth, sixth, seventh, and eighth microcells, as illustrated in FIG. 11C. The fifth microcell comprising a fifth protrusion structure having a fifth protrusion base; the sixth microcell comprises a sixth protrusion structure having a sixth protrusion base; the seventh microcell comprises a seventh protrusion structure having a seventh protrusion base; the eighth microcell comprises an eighth protrusion structure having an eighth protrusion base. The fifth microcell is adjacent to the sixth and seventh microcells. The sixth microcell is adjacent to the fifth, seventh, and eighth microcell. The seventh microcell is adjacent to the fifth, sixth, and eighth microcells. The eighth microcell is adjacent to the sixth and seventh microcells. The fifth protrusion base has a geometric shape of a symmetrical teardrop having a fifth axis, the fifth axis having a fifth direction. The sixth protrusion base has a geometric shape of a symmetrical teardrop having a sixth axis, the sixth axis having a sixth direction. The seventh protrusion base has a geometric shape of a symmetrical curved triangle having three axes, each of the three axes having a direction. The eighth protrusion base has a geometric shape of a symmetrical curved triangle having three axes, each of the three axes having a direction. In this example, the fifth axis is parallel to the sixth axis, the direction of the fifth axis being opposite to the direction of the sixth axis; one of the axes of the geometric shape of the seventh protrusion base is parallel to the fifth and sixth axes and has a direction that is the opposite to the fifth direction; one of the axes of the geometric shape of the eighth protrusion base is parallel to the fifth and sixth axes and has a direction that is the same as the fifth direction. The microcell layer may comprise multiple sets of the fifth, sixth, seventh, and eighth microcells. FIG. 11D illustrates a top view of a portion of an example of a microcell layer that comprises five sets of the first, second, third, and fourth microcells.

FIG. 11E is a top view illustration of a portion of a microcell layer of a variable light transmission device of the present invention. The portion of the microcell layer contains a set of eight microcells. These eight microcells correspond to the combined sets of the set of (i) the first, second, third, and fourth microcell set (of FIG. 11A) and (ii) the fifth, sixth, seventh, and eighth microcell set (of FIG. 11C). FIG. 11F illustrates a top view of a portion of an example of a microcell layer that comprises multiple sets of microcells, each set being presented by FIG. 11E.

FIG. 12B shows a Fraunhofer diffraction pattern, which is formed by the non-inventive variable light transmission device having an hexagon aperture, the top view of a portion of which is shown in FIG. 12A. The variable light transmission device of FIG. 12A has microcells with a conical protrusion structure and an hexagonal channel. The diffraction pattern shown in FIG. 12B includes highly visible linear components with decreasing light intensity as the linear component is further from the center of the light pattern.

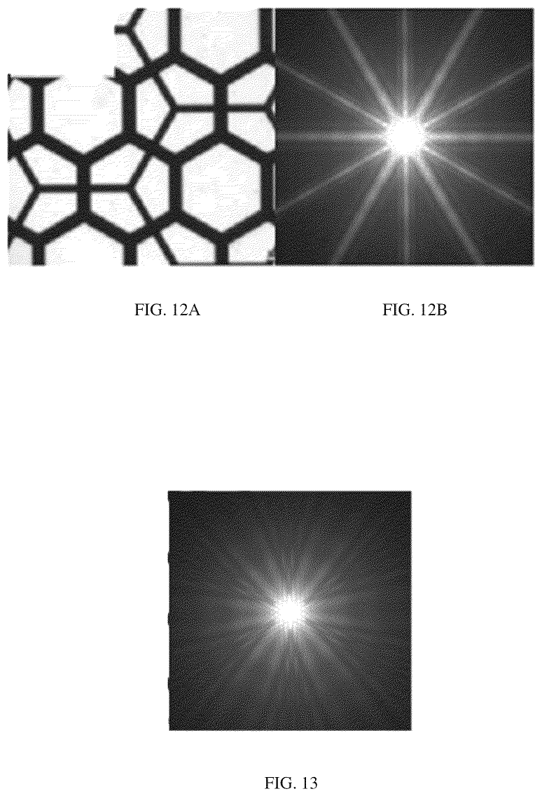

In contrast, FIG. 13 shows the diffraction pattern formed by the variable light transmission device 200, which is illustrated in FIGS. 3A, 3B, and 3C. The unique microcell structure of this inventive variable light transmission device significantly improves the diffraction pattern of the produced light and reduces the image blurriness. The design of the microcells of the inventive devices improves the observed images. The aperture diffraction in the inventive device is reduced because of (i) the use of various microcell types having different shapes of the protrusion base, and (ii) the curved features of the shape of the base of the channel, which is the intersection of the channel and the microcell bottom inside surface, and the variation in instead of the straight lines of the corresponding shape of the base of the channel in the design illustrated in the device of FIG. 12A.

The electrophoretic medium of the variable light transmissive devices of the present invention comprises electrically charged pigment particles, a charge control agent and non-polar liquid. Charge control agents are typically oligomeric or polymer materials that are soluble in the non-polar liquid of the electrophoretic medium. Charge control agents are surfactant-type molecules having one or more polar functional groups (head) and a non-polar part (tail). The electrophoretic medium may comprise a charge control agent in a concentration of from 0.1 weight percent to 10 weight percent by weight of the electrophoretic medium. The electrophoretic medium may comprise a charge control agent in a concentration of from 0.5 weight percent to 9 weight percent, from 0.7 weight percent to 8 weight percent, from 1 weight percent to 7 weight percent, or from 1 weight percent to 6 weight percent by weight of the electrophoretic medium.

The non-polar liquid of the electrophoretic medium may comprise an aliphatic hydrocarbon, a cycloaliphatic hydrocarbon, an aromatic hydrocarbon, a halogenated aliphatic hydrocarbon, a polydimethylsiloxane, or mixture thereof.

The electrophoretic medium may also comprise a flocculating agent, also called depletor. The depletor induces an osmotic pressure difference between pigment-pigment particle and pigment particle depletor molecules. As a result, bistability of the optical states (open and closed) of the device is enhanced. Depletors are typically polymeric material such as polyisobutylene and polydimethylsiloxane.

### Clauses

Clause 1: A variable light transmission device (200) comprising:
a first light transmissive electrode layer (202);
a second light transmissive electrode layer (207); and
a microcell layer (203), the microcell layer (203) being disposed between the first light transmissive electrode layer (202) and the second light transmissive electrode layer (207), the microcell layer (203) comprising a plurality of microcells (204) and a sealing layer (206), each microcell of the plurality of microcells (204) including an electrophoretic medium (209), the electrophoretic medium (209) comprising electrically charged pigment particles (223), a charge control agent, and a non-polar liquid, each microcell of the plurality of microcells (204) having a microcell opening (205), the sealing layer (206) spanning the microcell openings (205) of the plurality of microcells (204);
the sealing layer (206) of each microcell having an upper surface and a lower surface, the lower surface being in contact with the electrophoretic medium (209), the upper surface being in contact (i) with the first light transmissive electrode layer (202) or (ii) with an adhesive layer, the adhesive layer being disposed between the first light transmissive electrode layer (202) and the upper surface of the sealing layer (206);
each microcell of the plurality of microcells (204) comprising a microcell bottom layer (210), a protrusion structure (217), a microcell wall (212), and a channel (215), the microcell bottom layer (210) having a microcell bottom inside surface (211), the microcell bottom inside surface (211) consisting of an exposed microcell bottom inside surface (211a) and an unexposed microcell bottom inside surface (211b);
the protrusion structure (217) having a protrusion base (218), a protrusion surface (221), a protrusion apex (219), a protrusion height (220), and a protrusion volume, the protrusion apex (219) being a point of the protrusion structure having shorter distance from the microcell opening (205) than all other points of the protrusion structure (217), the protrusion height (220) being the distance between the protrusion base (218) and the protrusion apex (219), the protrusion surface (221) being a surface of the protrusion structure (217) that is in contact with the electrophoretic medium (209), the unexposed microcell bottom inside surface (211b) being in contact with the protrusion base (218); and the exposed microcell bottom inside surface (211a) being in contact with the electrophoretic medium (209);
the microcell wall (212) having a microcell wall inside surface (213) and a microcell wall upper surface (214), the microcell wall inside surface (213) being a surface of the microcell wall (212) of a microcell that is in contact with the electrophoretic medium (209), the microcell wall upper surface (214) being the surface of the microcell wall (212) that is in contact with the sealing layer (206);
the channel (215) having a channel height (216h), a channel base, a channel base width, an inner base perimeter, and an outer base perimeter, the channel height (216h) being 50% of the protrusion height (220), the inner base perimeter being the intersection of the microcell wall (212) and the exposed microcell bottom inside surface (211), the outer base perimeter being the intersection of the protrusion base and the exposed microcell bottom inside surface, the channel base width being the smaller distance between a point in the inner base perimeter and a point in the outer base perimeter;
the channel (215) having a three-dimensional shape that is defined by a space between the exposed microcell bottom inside surface (211a), the protrusion surface (221), a plane that is parallel to the microcell bottom inside surface (211), the plane having a distance from the microcell bottom inside surface (211) equal to the channel height (216h), and the microcell wall inside surface (213);
the protrusion structure having a three-dimensional shape consisting of one geometric solid or two or more geometric solids, the one geometric solid or at least one of the two or more geometric solids being a conoid, wherein the protrusion base is a geometric shape selected from the group consisting of a teardrop, a teardrop having a rounded end, an ellipse with two pointed ends, a lemon shape, a rounded-end lemon shape, a curved polygon, and a curved polygon with rounded vertices, the curved polygon and the curved polygon with rounded vertices having from 3 to 6 sides;
wherein application of a first electric field between the first light transmissive electrode layer (202) and the second light transmissive electrode layer (207) via a first waveform causes movement of the electrically charged pigment particles (223) towards the channel (215), resulting in switching of the variable light transmission device (200) to an open optical state;
wherein application of a second electric field between the first light transmissive electrode layer (202) and the second light transmissive electrode layer (207) via a second waveform causes a movement of the electrically charged pigment particles (223) towards the first light transmissive electrode layer (202), wherein the closed optical state has lower percent transparency than the open optical state.

Clause 2: The variable light transmission device of clause 1, wherein the microcell opening (205) of each microcell of the plurality of microcells (204) of the microcell layer (203) is a geometric shape, the geometric shape of the microcell opening (205) being the same as the geometric shape of the protrusion base of the microcell.

Clause 3: The variable light transmission device according to clause 1 or clause 2, wherein each microcell of the plurality of microcells (204) has a length of from 400 micrometers to 800 micrometers and a height of from 20 micrometers to 100 micrometers, and wherein the width of the channel of each microcell of the plurality of microcells (204) is from 10 micrometers to 30 micrometers.

Clause 4: The variable light transmission device according to any one of clause 1 or clause 3, wherein the protrusion height (220) is from 15 micrometers to 90 micrometers.

Clause 5: The variable light transmission device according to any one of clause 1 or clause 4, wherein the microcell layer comprises a set of two adjacent microcells, a first microcell and a second microcell, the first microcell comprising a first protrusion structure having a first protrusion base, the first protrusion base having a geometric shape of (i) a symmetrical teardrop or (ii) a symmetrical teardrop having a rounded end, the geometric shape of the first protrusion base having an axis, the axis having a direction, the second microcell comprising a second protrusion structure having a second protrusion base, the second protrusion base having a geometric shape of (iii) a symmetrical curved triangle or (iv) a symmetrical curved triangle with rounded vertices, the geometric shape of the second protrusion base having three axes, each of the three axes having a direction, wherein one of the three axes of the geometric shape of the second protrusion base is parallel to the axis of the geometric shape of the first protrusion base and having a direction that is the same as the direction of the axis of the geometric shape of the first protrusion base.

Clause 6: The variable light transmission device according to any one of clause 1 or clause 5, wherein the microcell layer comprises a set of two adjacent microcells, a third microcell and a fourth microcell, the third microcell comprising a third protrusion structure having a third protrusion base, the third protrusion base having a geometric shape of (i) a symmetrical teardrop or (ii) a symmetrical teardrop having a rounded end, the geometric shape of the third protrusion base having an axis, the fourth microcell comprising a fourth protrusion structure having a fourth protrusion base, the fourth protrusion base having a geometric shape of (iii) a symmetrical curved triangle or (iv) a symmetrical curved triangle with rounded vertices, the geometric shape of the fourth protrusion base having three axes, wherein one of the three axes of the geometric shape of the fourth protrusion base and the axis of the third protrusion base form an angle of from 30 to 60 degrees.

Clause 7: The variable light transmission device according to any one of clause 1 or clause 6, wherein the microcell layer comprises a set of four microcells, a first, second, third, and fourth microcells, the first microcell comprising a first protrusion structure having a first protrusion base, the second microcell comprising a second protrusion structure having a second protrusion base, the third microcell comprising a third protrusion structure having a third protrusion base, the fourth microcell comprising a fourth protrusion structure having a fourth protrusion base, the first microcell being adjacent to the second and third microcells, the second microcell being adjacent to the first, third and fourth microcells, the third microcell being adjacent to the first, second, and fourth microcells, the fourth microcell being adjacent to the second and third microcells, the first protrusion base having a geometric shape of (i) a symmetrical teardrop or (ii) a symmetrical teardrop having a rounded end, the geometric shape of the first protrusion base having a first axis, the first axis having a first direction, the second protrusion base having a geometric shape of (iii) a symmetrical teardrop or (iv) a symmetrical teardrop having a rounded end, the geometric shape of the second protrusion base having a second axis, the second axis having a second direction, the third protrusion base having a geometric shape of (v) a symmetrical curved triangle or (vi) a symmetrical curved triangle with rounded vertices, the geometric shape of the third protrusion base having three axes, each of the three axes having a direction, the fourth protrusion base having a geometric shape of (vii) a symmetrical curved triangle or (viii) a symmetrical curved triangle with rounded vertices, the geometric shape of the fourth protrusion base having three axes, each of the three axes having a direction, the first axis being parallel to the second axis, the direction of the first axis being opposite to the direction of the second axis, one of the axes of the geometric shape of the third protrusion base is parallel to the first and second axes, and having a direction that is the same as the first direction, one of the axes of the geometric shape of the fourth protrusion base is parallel to the first and second axes and having a direction that is the same as the second direction.

Clause 8: The variable light transmission device of clause 7, wherein the microcell layer comprises two or more sets of four microcells, each set consisting of the first, second, third, and fourth microcells.

Clause 9: The variable light transmission device according to any one of clause 1 or clause 8, wherein the microcell layer comprises a set of four microcells, a fifth, sixth, seventh, and eighth microcells, the fifth microcell comprising a fifth protrusion structure having a fifth protrusion base, the sixth microcell comprising a sixth protrusion structure having a sixth protrusion base, the seventh microcell comprising a seventh protrusion structure having a seventh protrusion base, the eighth microcell comprising an eighth protrusion structure having an eighth protrusion base, the fifth microcell being adjacent to the sixth and seventh microcells, the sixth microcell being adjacent to the fifth, seventh, and eighth microcell, the seventh microcell being adjacent to the fifth, sixth, and eighth microcells, the eighth microcell being adjacent to the sixth and seventh microcells, the fifth protrusion base having a geometric shape of (i) a symmetrical teardrop or (ii) a symmetrical teardrop having a rounded end, the geometric shape of the fifth protrusion base having a fifth axis, the fifth axis having a fifth direction, the sixth protrusion base having a geometric shape of (iii) a symmetrical teardrop or (iv) a symmetrical teardrop having a rounded end, the geometric shape of the sixth protrusion base having a sixth axis, the sixth axis having a sixth direction, the seventh protrusion base having a geometric shape of (v) a symmetrical curved triangle or (vi) a symmetrical curved triangle with rounded vertices, the geometric shape of the seventh protrusion base having three axes, each of the three axes having a direction, the eighth protrusion base having a geometric shape of (vii) a symmetrical curved triangle or (viii) a symmetrical curved triangle with rounded vertices, the geometric shape of the eighth protrusion base having three axes, each of the three axes having a direction, the fifth axis being parallel to the sixth axis, the direction of the fifth axis being opposite to the direction of the sixth axis, one of the axes of the geometric shape of the seventh protrusion base is parallel to the fifth and sixth axes and having a direction that is the opposite to the fifth direction, one of the axes of the geometric shape of the eighth protrusion base is parallel to the fifth and sixth axes and having a direction that is the same as the fifth direction.

Clause 10: The variable light transmission device of clause 9, wherein the microcell layer comprises two or more sets of four microcells, each set consisting of the fifth, sixth, seventh, and eighth microcells.

Clause 11: The variable light transmission device of clause 9, wherein the set of microcells comprises, in addition to the fifth, sixth, seventh, and eighth microcells, a ninth, tenth, eleventh, and twelfth microcells, the ninth microcell comprising a ninth protrusion structure having a ninth protrusion base, the tenth microcell comprising a tenth protrusion structure having a tenth protrusion base, the eleventh microcell comprising a eleventh protrusion structure having a eleventh protrusion base, the twelfth microcell comprising a twelfth protrusion structure having a twelfth protrusion base, the seventh microcell being adjacent to the fifth, sixth, eight, and ninth microcells, the eighth microcell being adjacent to the sixth, seventh, ninth, and tenth microcells, the ninth microcell being adjacent to the seventh, eight, tenth and eleventh microcells, the tenth microcell being adjacent to the eighth, ninth, eleventh, and twelfth microcells, the eleventh microcell being adjacent to the ninth, tenth, and twelfth microcells, the twelfth microcell being adjacent to the tenth, and eleventh microcells, the ninth protrusion base having a geometric shape of (i) a symmetrical teardrop or (ii) a symmetrical teardrop having a rounded end, the geometric shape of the ninth protrusion base having a ninth axis, the ninth axis having a ninth direction, the tenth protrusion base having a geometric shape of (iii) a symmetrical teardrop or (iv) a symmetrical teardrop having a rounded end, the geometric shape of the tenth protrusion base having a tenth axis, the tenth axis having a tenth direction, the eleventh protrusion base having a geometric shape of (v) a symmetrical curved triangle or (vi) a symmetrical curved triangle with rounded vertices, the geometric shape of the eleventh protrusion base having three axes, each of the three axes having a direction, the twelfth protrusion base having a geometric shape of (vii) a symmetrical curved triangle or (viii) a symmetrical curved triangle with rounded vertices, the geometric shape of the twelfth protrusion base having three axes, each of the three axes having a direction, the ninth axis being parallel to the tenth axis, the direction of the ninth axis being opposite to the direction of the tenth axis, one of the axes of the geometric shape of the eleventh protrusion base is parallel to the ninth and tenth axes, and having a direction that is the same as the ninth direction, one of the axes of the geometric shape of the twelfth protrusion base is parallel to the ninth and tenth axes and having a direction that is the same as the tenth direction, and the fifth axis and the ninth axis form an angle of from 30 to 60 degrees.

Clause 12: The variable light transmission device of clause 11, wherein the microcell layer comprises two or more sets of eight microcells, each set consisting of the fifth, sixth, seventh, eighth, ninth, tenth, eleventh, and twelfth microcells.

Clause 13: The variable light transmission device according to any one of clause 1 to clause 12, wherein the variable light transmission device comprises a microcell having a microcell wall inside surface (213) and a microcell bottom surface (211), wherein the microcell wall inside surface (213) and the microcell bottom surface (211) form an angle (φ), the angle (φ) being from 90 to 120 degrees.

Clause 14: The variable light transmission device according to any one of clause 1 to clause 13, wherein the variable light transmission device comprises (i) an adhesive layer, the adhesive layer being disposed between the first light transmissive electrode layer (202) and the sealing layer (206), (ii) a second adhesive layer, the second adhesive layer being disposed between the microcell layer (203) and the second light transmissive electrode layer (207), or (iii) both the adhesive layer and the second adhesive layer.

Clause 15: The variable light transmission device according to any one of clause 1 to clause 14, wherein the variable light transmission device comprises a light blocking layer (230) disposed between the microcell wall upper surface (214) and the sealing layer (206).

Clause 16: The variable light transmission device of clause 15, wherein, the light blocking layer (230) comprising light absorbing pigment.

Clause 17: The variable light transmission device of clause 16, wherein the light absorbing pigment of the light blocking layer (230) has black color.

Clause 18: The variable light transmission device according to any one of clause 1 to clause 17, wherein the second electric field causes a movement of the electrically charged pigment particles (223) towards the first light transmissive electrode layer (202) with a velocity, the velocity having a lateral component.

Clause 19: The variable light transmission device according to any one of clause 1 to clause 18, wherein the second waveform comprises at least one positive voltage and at least one negative voltage, the second waveform having a net positive or net negative impulse.

Clause 20: The variable light transmission device of clause 19, wherein the second waveform comprises an AC waveform, the AC waveform having a duty cycle of from 5% to 45%, or wherein the second waveform comprises a DC-offset waveform, which is formed by a superposition of a DC voltage component and an AC waveform.

Parts of the structures in the drawings: 101 teardrop tip; 102 teardrop head point; 103 teardrop axis; 111 pointed end of ellipse with two pointed ends; 113 axis of symmetry of ellipse with two pointed ends; 121 first end of lemon shape; 122 second end of lemon shape; 123 axis of lemon shape; 200, variable transmission device; 201 first light transmissive substrate; 202 first light-transmissive electrode layer; 203 microcell layer; 204 plurality or microcells; 205 microcell opening; 206 sealing layer; 207 second light-transmissive electrode layer; 208 second light transmissive substrate; 209 electrophoretic medium; 210 microcell bottom layer; 211 microcell bottom inside surface; 211a exposed microcell bottom inside surface; 211b unexposed microcell bottom inside surface; 212 microcell wall; 213 microcell wall inside surface; 214 microcell wall upper surface; 215 channel; 216h channel height; 217 protrusion structure; 218 protrusion base; 219 protrusion apex; 220 protrusion height; 221 protrusion surface; 223 electrically charged pigment particles; 230 light blocking layer; 250 first outside surface of variable light transmission device; 251 second outside surface of variable light transmission device; 502 electric field.

The invention claimed is:

1. A variable light transmission device (200) comprising:
a first light transmissive electrode layer (202);
a second light transmissive electrode layer (207); and
a microcell layer (203), the microcell layer (203) being disposed between the first light transmissive electrode layer (202) and the second light transmissive electrode layer (207), the microcell layer (203) comprising a plurality of microcells (204) and a sealing layer (206), each microcell of the plurality of microcells (204) including an electrophoretic medium (209), the electrophoretic medium (209) comprising electrically charged pigment particles (223), a charge control agent, and a non-polar liquid, each microcell of the plurality of microcells (204) having a microcell opening (205), the sealing layer (206) spanning the microcell openings (205) of the plurality of microcells (204);
the sealing layer (206) of each microcell having an upper surface and a lower surface, the lower surface being in contact with the electrophoretic medium (209), the upper surface being in contact (i) with the first light transmissive electrode layer (202) or (ii) with an adhesive layer, the adhesive layer being disposed between the first light transmissive electrode layer (202) and the upper surface of the sealing layer (206);
each microcell of the plurality of microcells (204) comprising a microcell bottom layer (210), a protrusion structure (217), a microcell wall (212), and a channel (215), the microcell bottom layer (210) having a microcell bottom inside surface (211), the microcell bottom inside surface (211) consisting of an exposed microcell bottom inside surface (211a) and an unexposed microcell bottom inside surface (211b);
the protrusion structure (217) having a protrusion base (218), a protrusion surface (221), a protrusion apex (219), a protrusion height (220), and a protrusion volume, the protrusion apex (219) being a point of the protrusion structure having shorter distance from the microcell opening (205) than all other points of the protrusion structure (217), the protrusion height (220) being the distance between the protrusion base (218) and the protrusion apex (219), the protrusion surface (221) being a surface of the protrusion structure (217) that is in contact with the electrophoretic medium (209), the unexposed microcell bottom inside surface (211b) being in contact with the protrusion base (218);
and the exposed microcell bottom inside surface (211a) being in contact with the electrophoretic medium (209);
the microcell wall (212) having a microcell wall inside surface (213) and a microcell wall upper surface (214), the microcell wall inside surface (213) being a surface of the microcell wall (212) of a microcell that is in contact with the electrophoretic medium (209), the microcell wall upper surface (214) being the surface of the microcell wall (212) that is in contact with the sealing layer (206);
the channel (215) having a channel height (216h), a channel base, a channel base width, an inner base perimeter, and an outer base perimeter, the channel height (216h) being 50% of the protrusion height (220), the inner base perimeter being the intersection of the microcell wall (212) and the exposed microcell bottom inside surface (211), the outer base perimeter being the intersection of the protrusion base and the exposed microcell bottom inside surface, the channel base width being the smaller distance between a point in the inner base perimeter and a point in the outer base perimeter;
the channel (215) having a three-dimensional shape that is defined by a space between the exposed microcell bottom inside surface (211a), the protrusion surface (221), a plane that is parallel to the microcell bottom inside surface (211), the plane having a distance from the microcell bottom inside surface (211) equal to the channel height (216h), and the microcell wall inside surface (213);
the protrusion structure having a three-dimensional shape consisting of one geometric solid or two or more geometric solids, the one geometric solid or at least one of the two or more geometric solids being a conoid, wherein the protrusion base is a geometric shape selected from the group consisting of a teardrop, a teardrop having a rounded end, an ellipse with two pointed ends, a lemon shape, a rounded-end lemon shape, a curved polygon, and a curved polygon with rounded vertices, the curved polygon and the curved polygon with rounded vertices having from 3 to 6 sides;
wherein application of a first electric field between the first light transmissive electrode layer (202) and the second light transmissive electrode layer (207) via a first waveform causes movement of the electrically charged pigment particles (223) towards the channel (215), resulting in switching of the variable light transmission device (200) to an open optical state;
wherein application of a second electric field between the first light transmissive electrode layer (202) and the second light transmissive electrode layer (207) via a second waveform causes a movement of the electrically charged pigment particles (223) towards the first light transmissive electrode layer (202), wherein the closed optical state has lower percent transparency than the open optical state.

2. The variable light transmission device of claim 1, wherein the microcell opening (205) of each microcell of the plurality of microcells (204) of the microcell layer (203) is a geometric shape, the geometric shape of the microcell opening (205) being the same as the geometric shape of the protrusion base of the microcell.

3. The variable light transmission device of claim 1, wherein each microcell of the plurality of microcells (204) has a length of from 400 micrometers to 800 micrometers and a height of from 20 micrometers to 100 micrometers, and wherein the width of the channel of each microcell of the plurality of microcells (204) is from 10 micrometers to 30 micrometers.

4. The variable light transmission device of claim 1, wherein the protrusion height (220) is from 15 micrometers to 90 micrometers.

5. The variable light transmission device of claim 1, wherein the microcell layer comprises a set of two adjacent microcells, a first microcell and a second microcell, the first microcell comprising a first protrusion structure having a first protrusion base, the first protrusion base having a geometric shape of (i) a symmetrical teardrop or (ii) a symmetrical teardrop having a rounded end, the geometric shape of the first protrusion base having an axis, the axis having a direction, the second microcell comprising a second protrusion structure having a second protrusion base, the second protrusion base having a geometric shape of (iii) a symmetrical curved triangle or (iv) a symmetrical curved triangle with rounded vertices, the geometric shape of the second protrusion base having three axes, each of the three axes having a direction, wherein one of the three axes of the geometric shape of the second protrusion base is parallel to the axis of the geometric shape of the first protrusion base and having a direction that is the same as the direction of the axis of the geometric shape of the first protrusion base.

6. The variable light transmission device of claim 1, wherein the microcell layer comprises a set of two adjacent microcells, a third microcell and a fourth microcell, the third microcell comprising a third protrusion structure having a third protrusion base, the third protrusion base having a geometric shape of (i) a symmetrical teardrop or (ii) a symmetrical teardrop having a rounded end, the geometric shape of the third protrusion base having an axis, the fourth microcell comprising a fourth protrusion structure having a fourth protrusion base, the fourth protrusion base having a geometric shape of (iii) a symmetrical curved triangle or (iv) a symmetrical curved triangle with rounded vertices, the geometric shape of the fourth protrusion base having three axes, wherein one of the three axes of the geometric shape of the fourth protrusion base and the axis of the third protrusion base form an angle of from 30 to 60 degrees.

7. The variable light transmission device of claim 1, wherein the microcell layer comprises a set of four microcells, a first, second, third, and fourth microcells, the first microcell comprising a first protrusion structure having a first protrusion base, the second microcell comprising a second protrusion structure having a second protrusion base, the third microcell comprising a third protrusion structure having a third protrusion base, the fourth microcell comprising a fourth protrusion structure having a fourth protrusion base, the first microcell being adjacent to the second and third microcells, the second microcell being adjacent to the first, third and fourth microcells, the third microcell being adjacent to the first, second, and fourth microcells, the fourth microcell being adjacent to the second and third microcells, the first protrusion base having a geometric shape of (i) a symmetrical teardrop or (ii) a symmetrical teardrop having a rounded end, the geometric shape of the first protrusion base having a first axis, the first axis having a first direction, the second protrusion base having a geometric shape of (iii) a symmetrical teardrop or (iv) a symmetrical teardrop having a rounded end, the geometric shape of the second protrusion base having a second axis, the second axis having a second direction, the third protrusion base having a geometric shape of (v) a symmetrical curved triangle or (vi) a symmetrical curved triangle with rounded vertices, the geometric shape of the third protrusion base having three axes, each of the three axes having a direction, the fourth protrusion base having a geometric shape of (vii) a symmetrical curved triangle or (viii) a symmetrical curved triangle with rounded vertices, the geometric shape of the fourth protrusion base having three axes, each of the three axes having a direction, the first axis being parallel to the second axis, the direction of the first axis being opposite to the direction of the second axis, one of the axes of the geometric shape of the third protrusion base is parallel to the first and second axes, and having a direction that is the same as the first direction, one of the axes of the geometric shape of the fourth protrusion base is parallel to the first and second axes and having a direction that is the same as the second direction.

8. The variable light transmission device of claim 7, wherein the microcell layer comprises two or more sets of four microcells, each set consisting of the first, second, third, and fourth microcells.

9. The variable light transmission device of claim 1, wherein the microcell layer comprises a set of four microcells, a fifth, sixth, seventh, and eighth microcells, the fifth microcell comprising a fifth protrusion structure having a fifth protrusion base, the sixth microcell comprising a sixth protrusion structure having a sixth protrusion base, the seventh microcell comprising a seventh protrusion structure having a seventh protrusion base, the eighth microcell comprising an eighth protrusion structure having an eighth protrusion base, the fifth microcell being adjacent to the sixth and seventh microcells, the sixth microcell being adjacent to the fifth, seventh, and eighth microcell, the seventh microcell being adjacent to the fifth, sixth, and eighth microcells, the eighth microcell being adjacent to the sixth and seventh microcells, the fifth protrusion base having a geometric shape of (i) a symmetrical teardrop or (ii) a symmetrical teardrop having a rounded end, the geometric shape of the fifth protrusion base having a fifth axis, the fifth axis having a fifth direction, the sixth protrusion base having a geometric shape of (iii) a symmetrical teardrop or (iv) a symmetrical teardrop having a rounded end, the geometric shape of the sixth protrusion base having a sixth axis, the sixth axis having a sixth direction, the seventh protrusion base having a geometric shape of (v) a symmetrical curved triangle or (vi) a symmetrical curved triangle with rounded vertices, the geometric shape of the seventh protrusion base having three axes, each of the three axes having a direction, the eighth protrusion base having a geometric shape of (vii) a symmetrical curved triangle or (viii) a symmetrical curved triangle with rounded vertices, the geometric shape of the eighth protrusion base having three axes, each of the three axes having a direction, the fifth axis being parallel to the sixth axis, the direction of the fifth axis being opposite to the direction of the sixth axis, one of the axes of the geometric shape of the seventh protrusion base is parallel to the fifth and sixth axes and having a direction that is the opposite to the fifth direction, one of the axes of the geometric shape of the eighth protrusion base is parallel to the fifth and sixth axes and having a direction that is the same as the fifth direction.

10. The variable light transmission device of claim 9, wherein the microcell layer comprises two or more sets of four microcells, each set consisting of the fifth, sixth, seventh, and eighth microcells.

11. The variable light transmission device of claim 9, wherein the set of microcells comprises, in addition to the fifth, sixth, seventh, and eighth microcells, a ninth, tenth, eleventh, and twelfth microcells, the ninth microcell comprising a ninth protrusion structure having a ninth protrusion base, the tenth microcell comprising a tenth protrusion structure having a tenth protrusion base, the eleventh microcell comprising a eleventh protrusion structure having a eleventh protrusion base, the twelfth microcell comprising a twelfth protrusion structure having a twelfth protrusion base, the seventh microcell being adjacent to the fifth, sixth, eight, and ninth microcells, the eighth microcell being adjacent to the sixth, seventh, ninth, and tenth microcells, the ninth microcell being adjacent to the seventh, eight, tenth and eleventh microcells, the tenth microcell being adjacent to the eighth, ninth, eleventh, and twelfth microcells, the eleventh microcell being adjacent to the ninth, tenth, and twelfth microcells, the twelfth microcell being adjacent to the tenth, and eleventh microcells, the ninth protrusion base having a geometric shape of (i) a symmetrical teardrop or (ii) a symmetrical teardrop having a rounded end, the geometric shape of the ninth protrusion base having a ninth axis, the ninth axis having a ninth direction, the tenth protrusion base having a geometric shape of (iii) a symmetrical teardrop or (iv) a symmetrical teardrop having a rounded end, the geometric shape of the tenth protrusion base having a tenth axis, the tenth axis having a tenth direction, the eleventh protrusion base having a geometric shape of (v) a symmetrical curved triangle or (vi) a symmetrical curved triangle with rounded vertices, the geometric shape of the eleventh protrusion base having three axes, each of the three axes having a direction, the twelfth protrusion base having a geometric shape of (vii) a symmetrical curved triangle or (viii) a symmetrical curved triangle with rounded vertices, the geometric shape of the twelfth protrusion base having three axes, each of the three axes having a direction, the ninth axis being parallel to the tenth axis, the direction of the ninth axis being opposite to the direction of the tenth axis, one of the axes of the geometric shape of the eleventh protrusion base is parallel to the ninth and tenth axes, and having a direction that is the same as the ninth direction, one of the axes of the geometric shape of the twelfth protrusion base is parallel to the ninth and tenth axes and having a direction that is the same as the tenth direction, and the fifth axis and the ninth axis form an angle of from 30 to 60 degrees.

12. The variable light transmission device of claim 11, wherein the microcell layer comprises two or more sets of eight microcells, each set consisting of the fifth, sixth, seventh, eighth, ninth, tenth, eleventh, and twelfth microcells.

13. The variable light transmission device of claim 1, wherein the variable light transmission device comprises a microcell having a microcell wall inside surface (213) and a microcell bottom surface (211), wherein the microcell wall inside surface (213) and the microcell bottom surface (211) form an angle (φ), the angle (φ) being from 90 to 120 degrees.

14. The variable light transmission device of claim 1, wherein the variable light transmission device comprises (i) an adhesive layer, the adhesive layer being disposed between the first light transmissive electrode layer (202) and the sealing layer (206), (ii) a second adhesive layer, the second adhesive layer being disposed between the microcell layer (203) and the second light transmissive electrode layer (207), or (iii) both the adhesive layer and the second adhesive layer.

15. The variable light transmission device of claim 1, wherein the variable light transmission device comprises a light blocking layer (230) disposed between the microcell wall upper surface (214) and the sealing layer (206).

16. The variable light transmission device of claim 15, wherein, the light blocking layer (230) comprising light absorbing pigment.

17. The variable light transmission device of claim 16, wherein the light absorbing pigment of the light blocking layer (230) has black color.

18. The variable light transmission device of claim 1, wherein the second electric field causes a movement of the electrically charged pigment particles (223) towards the first light transmissive electrode layer (202) with a velocity, the velocity having a lateral component.

19. The variable light transmission device of claim 1, wherein the second waveform comprises at least one positive voltage and at least one negative voltage, the second waveform having a net positive or net negative impulse.

20. The variable light transmission device of claim 19, wherein the second waveform comprises an AC waveform, the AC waveform having a duty cycle of from 5% to 45%, or wherein the second waveform comprises a DC-offset waveform, which is formed by a superposition of a DC voltage component and an AC waveform.
